(19) United States
(12) Patent Application Publication
(10) Pub. No.: US 2023/0268561 A1
(43) Pub. Date: Aug. 24, 2023

(54) RECHARGEABLE BATTERY WITH TEMPERATURE ACTIVATED CURRENT INTERRUPTER

(71) Applicant: American Lithium Energy Corporation, Carlsbad, CA (US)

(72) Inventors: Jiang Fan, San Diego, CA (US); Dengguo Wu, San Diego, CA (US)

(21) Appl. No.: 18/161,012

(22) Filed: Jan. 27, 2023

Related U.S. Application Data
(63) Continuation of application No. 16/988,516, filed on Aug. 7, 2020, now abandoned.
Application No. 16/988,516 is a continuation of application No. 14/952,755, filed on Nov. 25, 2015, now abandoned.
(60) Provisional application No. 62/114,006, filed on Feb. 9, 2015.
(60) Provisional application No. 62/114,508, filed on Feb. 10, 2015.
(60) Provisional application No. 62/084,454, filed on Nov. 25, 2014.

(51) Int. Cl. H01M 10/42; H01M 50/581; H01M 10/0525

(52) U.S. Cl. CPC H01M 10/4235; H01M 50/581; H01M 2200/10; H01M 10/0525

(57) ABSTRACT

A high energy density rechargeable (HEDR) metal-ion battery includes an anode and a cathode energy layer, a separator for separating the anode and cathode energy layers, and at least one current collector for transferring electrons to and from either the anode or cathode energy layer. The HEDR battery has an upper temperature safety limit for avoiding thermal runaway. The HEDR battery further includes an interrupt layer that activates upon exposure to temperature at or above the upper temperature safety limit. When the interrupt layer is unactivated, it is laminated between the separator and one of the current collectors. When activated, the interrupt layer delaminates, interrupting current through the battery. The interrupt layer includes a temperature sensitive decomposable component that, upon exposure to temperature at or above the upper temperature safety limit, evolves a gas upon decomposition. The evolved gas delaminates the interrupt layer, interrupting current through the battery.

### CROSS-REFERENCE TO RELATED APPLICATIONS

This application claims priority under 35 U.S.C. § 119 (e) to the following three Provisional Applications: U.S. Provisional Application No. 62/084,454, filed Nov. 25, 2014, titled “Battery Safety Device;” U.S. Provisional Application No. 62/114,006, filed Feb. 9, 2015, titled “Rechargeable Battery with Temperature Activated Current Interrupter;” and U.S. Provisional Application No. 62/114,508, filed Feb. 10, 2015, titled “Rechargeable Battery with Internal Current Limiter and Interrupter,” the disclosures of which are all hereby incorporate by reference herein, each in its entirety.

### BACKGROUND

### Technical Field

This disclosure relates to an internal current limiter or current interrupter used to protect a battery in the event of an internal short circuit or overcharge leads to thermal runaway. In particular, it relates to a high energy density rechargeable (HEDR) battery with improved safety.

### Background

There is a need for rechargeable battery systems with enhanced safety that have a high energy density and hence are capable of storing and delivering large amounts of electrical energy per unit volume and/or weight. Such stable high energy battery systems have significant utility in a number of applications including military equipment, communication equipment, and robotics.

An example of a high energy density rechargeable (HEDR) battery commonly in use is the lithium-ion battery.

A lithium-ion battery is a rechargeable battery wherein lithium ions move from the negative electrode to the positive electrode during discharge and back when charging. Lithium-ion batteries can be dangerous under some conditions and can pose a safety hazard. The fire energy content (electrical+chemical) of lithium cobalt-oxide cells is about 100 to 150 kJ per Ah (kiloJoule per Amp-hour), most of it chemical. If overcharged or overheated, Li-ion batteries may suffer thermal runaway and cell rupture. In extreme cases, this can lead to combustion. Also, short-circuiting the battery, either externally or internally, will cause the battery to overheat and possibly to catch fire.

### Overcharge

In a lithium-ion battery, useful work is performed when electrons flow through a closed external circuit. However, in order to maintain charge neutrality, for each electron that flows through the external circuit, there must be a corresponding lithium ion that is transported from one electrode to the other. The electric potential driving this transport is achieved by oxidizing a transition metal. For example, cobalt (Co), from Co³⁺ to Co⁴⁺ during charge and reduced from Co⁴⁺ to Co³⁺ during discharge. Conventionally, Li₁₋ₓ CoO₂ may be employed, where the coefficient x represents the molar fraction of both the Li ion and the oxidative state of CoO₂, viz., Co³⁺ or Co⁴⁺. Employing these conventions, the positive electrode half-reaction for the lithium cobalt battery is represented as follows:

LiCoO₂⇄Li₁₋ₓCoO₂+xLi⁺+xe⁻

The negative electrode half reaction is represented as follows:

xLi⁺+xe⁻+xC₆⇄xLiC₆

The cobalt electrode reaction is reversible only for x<0.5, limiting the depth of discharge allowable. Overcharge leads to the synthesis of cobalt(IV) oxide, as follows:

LiCoO₂→Li⁺+CoO₂+e⁻

Overcharge is irreversible and can lead to thermal runaway.

### Internal Short Circuit

Lithium ion batteries employ a separator between the negative and positive electrodes to electrically separate the two electrodes from one another while allowing lithium ions to pass through. When the battery performs work by passing electrons through an external circuit, the permeability of the separator to lithium ions enables the battery to close the circuit. Short circuiting the separator by providing a conductive path across it allows the battery to discharge rapidly. A short circuit across the separator can result from improper charging and discharging. More particularly, improper charging and discharging can lead to the deposition of a metallic lithium dendrite within the separator so as to provide a conductive path for electrons from one electrode to the other. The lower resistance of this conductive path allows for rapid discharge and the generation of significant joule heat. Overheating and thermal runaway can result.

### Thermal Runaway

If the heat generated by a lithium ion battery exceeds its heat dissipation capacity, the battery can become susceptible to thermal runaway, resulting in overheating and, under some circumstances, to destructive results such as fire or violent explosion. Thermal runaway is a positive feedback loop wherein an increase in temperature changes the system so as to cause further increases in temperature. The excess heat can result from battery mismanagement, battery defect, accident, or other causes. However, the excess heat generation often results from increased joule heating due to excessive internal current or from exothermic reactions between the positive and negative electrodes. Excessive internal current can result from a variety of causes, but a lowering of the internal resistance due to separator short circuit is one possible cause. Heat resulting from a separator short circuit can cause a further breach within the separator, leading to a mixing of the reagents of the negative and positive electrodes and the generation of further heat due to the resultant exothermic reaction.

A thermally activated internal current interrupter can interrupt the internal circuit of the lithium ion battery before thermal runaway takes hold.

### SUMMARY

Provided in some embodiments herein is a high energy density rechargeable (HEDR) metal-ion battery that includes an anode energy layer, a cathode energy layer, a separator for separating the anode energy layer from the cathode energy layer, at least one current collector for transferring electrons to and from either the anode or cathode energy layer, the high energy density rechargeable metal-ion battery having an upper temperature safety limit for avoiding thermal runaway, and an interrupt layer activatable for interrupting current within high energy density rechargeable metal-ion battery upon exposure to temperature at or above the upper temperature safety limit, the interrupt layer interposed between the separator and one of the current collectors, the interrupt layer, when unactivated, being laminated between the separator and one of the current collectors for conducting current therethrough, the interrupt layer, when activated, being delaminated for interrupting current through the high energy density rechargeable metal-ion battery, the interrupt layer including a temperature sensitive decomposable component for decomposing upon exposure to temperature at or above the upper temperature safety limit, the temperature sensitive decomposable component for evolving a gas upon decomposition, the evolved gas for delaminating the interrupt layer for interrupting current through the high energy density metal-ion battery, in which the high energy density rechargeable metal-ion battery avoids thermal runaway by activation of the interrupt layer upon exposure to temperature at or above the upper temperature safety limit for interrupting current in high energy density rechargeable metal-ion battery.

The following features can be present in the HEDR metal-ion battery in any suitable combination. The interrupt layer can be porous. The temperature sensitive decomposable component can include a ceramic powder. The interrupt layer can have a composition comprising the ceramic powder, a binder, and a conductive component. The ceramic powder can define an interstitial space. The binder can partially fill the interstitial space for binding the ceramic powder. The conductive component can be dispersed within the binder for imparting conductivity to the interrupt layer. The interstitial space can remain partially unfilled for imparting porosity and permeability to the interrupt layer. The interrupt layer can include greater than 30% ceramic powder by weight. The interrupt layer can include greater than 50% ceramic powder by weight. The interrupt layer can include greater than 70% ceramic powder by weight. The interrupt layer can include greater than 75% ceramic powder by weight. The interrupt layer can include greater than 80% ceramic powder by weight. The interrupt layer can be permeable to transport of ionic charge carriers. The interrupt layer can be non-porous and have a composition that includes a non-conductive filler, a binder for binding the non-conductive filler, and a conductive component dispersed within the binder for imparting conductivity to the interrupt layer. The interrupt layer can be impermeable to transport of ionic charge carriers. The interrupt layer can be sacrificial at temperatures above the upper temperature safety limit. The interrupt layer can include a ceramic powder that chemically decomposes above the upper temperature safety limit for evolving a fire retardant gas. The current collector can include an anode current collector for transferring electrons to and from the anode energy layer, wherein the interrupt layer being interposed between the separator and the anode current collector. The interrupt layer can be interposed between the anode current collector and the anode energy layer. The interrupt layer can be interposed between the anode energy layer and the separator. The anode energy layer of the HEDR battery can include a first anode energy layer; and a second anode energy layer interposed between the first anode energy and the separator, wherein the interrupt layer being interposed between the first anode energy layer and the second anode energy layer. The current collector can include a cathode current collector for transferring electrons to and from the cathode energy layer, wherein the interrupt layer is interposed between the separator and the cathode current collector. The interrupt layer can be interposed between the cathode current collector and the cathode energy layer. The interrupt layer can be interposed between the cathode energy layer and the separator. The cathode energy layer can include a first cathode energy layer and a second cathode energy layer interposed between the first cathode energy and the separator, wherein the interrupt layer is interposed between the first cathode energy layer and the second cathode energy layer. The HEDR battery can further include two current collectors that include an anode current collector for transferring electrons to and from the anode energy layer and a cathode current collector for transferring electrons to and from the cathode energy layer, in which the interrupt layer includes an anode interrupt layer and a cathode interrupt layer, the anode interrupt layer interposed between the separator and the anode current collector, the cathode interrupt layer interposed between the separator and the cathode current collector.

In a related aspect, a method is presented for interrupting current within a high energy density rechargeable metal-ion battery upon exposure to temperature at or above an upper temperature safety limit for avoiding thermal runaway, that includes: raising the temperature of the high energy density rechargeable metal-ion battery above the upper temperature safety limit, and activating the interrupt layer for interrupting current through the high energy density metal-ion battery. The high energy density rechargeable metal-ion battery can include: an anode energy layer; a cathode energy layer; a separator separating the anode energy layer from the cathode energy layer; a current collector for transferring electrons to and from either the anode or cathode energy layer; and an interrupt layer, the interrupt layer interposed between the separator and one of the current collectors, the interrupt layer, when unactivated, being laminated between the separator and one of the current collectors for conducting current therethrough, the interrupt layer, when activated, being delaminated for interrupting current through the lithium ion battery, the interrupt layer comprising a temperature sensitive decomposable component for decomposing upon exposure to temperature at or above the upper temperature safety limit, the temperature sensitive decomposable component for evolving a gas upon decomposition, the evolved gas for delaminating the interrupt layer for interrupting current through the high energy density metal-ion battery; whereby thermal runaway by the high energy density rechargeable metal-ion battery is avoided by interruption of current therethrough.

One aspect of the invention is directed to an improved high energy density rechargeable (HEDR) metal-ion battery of a type that includes an anode energy layer, a cathode energy layer, a separator for separating the anode energy layer from the cathode energy layer, and at least one current collector for transferring electrons to and from either the anode or cathode energy layer. The high energy density rechargeable metal-ion battery has an upper temperature safety limit for avoiding thermal runaway. The improvement comprises an interrupt layer activatable for interrupting current within the lithium ion battery upon exposure to temperature at or above the upper temperature safety limit. The interrupt layer is interposed between the separator and one of the current collectors. The interrupt layer, when unactivated, is laminated between the separator and one of the current collectors for conducting current therethrough. The interrupt layer, when activated, is delaminated for interrupting current through the lithium ion battery. The interrupt layer includes a temperature sensitive decomposable component for decomposing upon exposure to temperature at or above the upper temperature safety limit. The temperature sensitive decomposable component serves to evolve a gas upon decomposition. The evolved gas serves to delaminate the interrupt layer for interrupting current through the lithium-ion battery. The high energy density rechargeable metal-ion battery avoids thermal runaway by activation of the interrupt layer upon exposure to temperature at or above the upper temperature safety for interrupting current the lithium ion battery.

In some embodiments, the interrupt layer may be porous and the temperature sensitive decomposable component may be a ceramic powder. The interrupt layer has a composition that includes the ceramic powder, a binder, and a conductive component, the ceramic powder defines an interstitial space. The binder serves to for partially fill the interstitial space for binding the ceramic powder. The conductive component is dispersed within the binder for imparting conductivity to the interrupt layer. The interstitial space remains partially unfilled for imparting porosity and permeability to the interrupt layer. Furthermore, the interrupt layer may be compressed for reducing the unfilled interstitial space and increasing the binding of the ceramic powder by the binder. More particularly, the ceramic powder may have a weight percent of the interrupt layer greater than 30%; alternatively, the ceramic powder may have a weight percent of the interrupt layer greater than 50%; alternatively, the ceramic powder may have a weight percent of the interrupt layer greater than 70%; alternatively, the ceramic powder may have a weight percent of the interrupt layer greater than 75%; alternatively, the ceramic powder may have a weight percent of the interrupt layer greater than 80%. The interrupt layer may be permeable to transport of ionic charge carriers.

In some embodiments, the interrupt layer may be non-porous and have a composition including a non-conductive filler, a binder for binding the non-conductive filler, and a conductive component dispersed within the binder for imparting conductivity to the interrupt layer. The interrupt layer may be impermeable to transport of ionic charge carriers.

In some embodiments, the interrupt layer is sacrificial at temperatures above the upper temperature safety limit. The interrupt layer may include a ceramic powder that chemically decomposes above the upper temperature safety limit for evolving a fire retardant gas.

In some embodiments, the current collector includes an anode current collector for transferring electrons to and from the anode energy layer. In this embodiment, the interrupt layer is interposed between the separator and the anode current collector. Alternatively, the interrupt layer is interposed between the anode current collector and the anode energy layer. Alternatively, interrupt layer is interposed between the anode energy layer and the separator.

In some embodiments, the anode energy layer includes a first anode energy layer and a second anode energy layer interposed between the first anode energy and the separator. In this embodiment, the interrupt layer may be interposed between the first anode energy layer and the second anode energy layer.

In some embodiments, the current collector includes a cathode current collector for transferring electrons to and from the cathode energy layer. In this embodiment, the interrupt layer may be interposed between the separator and the cathode current collector. Alternatively, the interrupt layer may be interposed between the cathode current collector and the cathode energy layer. Alternatively, the interrupt layer may be interposed between the cathode energy layer and the separator.

In some embodiments, the cathode energy layer includes a first cathode energy layer and a second cathode energy layer interposed between the first cathode energy and the separator. In this embodiment, the interrupt layer may be interposed between the first cathode energy layer and the second cathode energy layer.

In some embodiments, the improved high energy density rechargeable metal-ion battery cell is of a type that has two current collectors, viz., an anode current collector for transferring electrons to and from the anode energy layer and a cathode current collector for transferring electrons to and from the cathode energy layer. In this embodiment, the interrupt layer includes an anode interrupt layer and a cathode interrupt layer. The anode interrupt layer is interposed between the separator and the anode current collector. The cathode interrupt layer is interposed between the separator and the cathode current collector.

In a related aspect, a method is provided in some embodiments for interrupting current within a lithium ion battery upon exposure to temperature at or above an upper temperature safety limit for avoiding thermal runaway. In the first step of the method, the temperature of the high energy density rechargeable metal-ion battery is commenced to rise above the upper temperature safety limit. The high energy density rechargeable metal-ion battery includes an anode energy layer, a cathode energy layer, a separator separating the anode energy layer from the cathode energy layer, a current collector for transferring electrons to and from either the anode or cathode energy layer, and an interrupt layer. The interrupt layer is interposed between the separator and one of the current collectors. The interrupt layer, when unactivated, is laminated between the separator and one of the current collectors for conducting current therethrough. The interrupt layer, when activated, is delaminated for interrupting current through the lithium ion battery. The interrupt layer includes a temperature sensitive decomposable component for decomposing upon exposure to temperature at or above the upper temperature safety limit. The temperature sensitive decomposable component serves to evolve a gas upon decomposition. The evolved gas serves to delaminate the interrupt layer for interrupting current through the lithium-ion battery. In the second step of the method, the interrupt layer is activated for interrupting current through the lithium-ion battery. As a result, thermal runaway by the high energy density rechargeable metal-ion battery is avoided by interruption of current therethrough.

### BRIEF DESCRIPTION OF DRAWINGS

FIGS. 1A-1G illustrate schematic representations of exemplary configurations of film-type lithium ion batteries having one or more gas generating layers that serve as current interrupters for protecting the battery against overheating in the event of an internal short circuit. Gas generation is triggered by an elevation in temperature.

FIGS. 2A-2E illustrate cross sectional views of prior art film-type lithium ion batteries (FIGS. 2A and B) and of film-type lithium ion batteries with current interrupters, as described herein (FIGS. 2C and D).

FIGS. 3A-3E illustrate cross sectional views of prior art film-type lithium ion batteries (FIGS. 3A and B) and of film-type lithium ion batteries with current interrupters, as described herein (FIGS. 3C and D).

FIGS. 4A-4E illustrate cross sectional views of prior art film-type lithium ion batteries (FIGS. 4A and B) and of film-type lithium ion batteries with current interrupters, as described herein (FIGS. 4C and D).

FIGS. 5A-5E illustrate cross sectional views of prior art film-type lithium ion batteries (FIGS. 5A and B) and of film-type lithium ion batteries with current interrupters, as described herein (FIGS. 5C and D).

FIGS. 6A-6C illustrates exemplary structures for the gas generating layer (8).

FIGS. 7A and 7B show exemplified Cell compositions.

FIG. 8 illustrates the various positive electrode formulations use in chemical decomposition voltage measurements.

FIG. 9 illustrates the resistance of Cell #2 at 3.6V vs graphite in relation to the temperature increase. The resistance decreased about 10 times with the increase in the temperature.

FIG. 10 illustrates the resistance of Cell #3 (positive electrode with the CaCO3 ceramic layer) at 0V, 3.646V, and 4.11V, respectively, voltage vs graphite in relation to the temperature increase. The resistance increases slightly for zero voltage, and dramatically for 3.646V and 4.11 V.

FIG. 11 illustrates the resistance of Cell #4 (positive electrode with the Al₂O₃ and CaCO₃ ceramic layer) at 0V and 3.655V, respectively, voltage vs graphite in relation to the temperature increase. The resistance increases slightly for zero voltage, and dramatically for 3.655 V.

FIG. 12 illustrates the discharge capacity of Cell #1 (no any resistive layer) vs the cell voltage at 1 A, 3 A, 6 A and 10 A.

FIG. 13 illustrates the discharge capacity of Cell #3 (85.2% CaCO₃ based resistive layer) vs the cell voltage at 1 A, 3 A, 6 A and 10 A. The cell discharge capability decreases significantly with the increase in the cell discharge current with this particular resistive layer.

FIG. 14 summarizes the cell impedance and discharge capacities at 1 A, 3 A, 6 A and 10 A and their corresponding ration of the capacity at 3 A, 6 A or 10 A over that at 1 A for Cell #1 (baseline), #3, #4, #5, and #6. The cell impedance at 1 KHz goes up with the resistive and gas-generator layer. The resistive layer has caused the increase in the cell impedance since all cells with the resistive layer gets higher impedance while the cell discharge capacity depends on the individual case.

FIG. 15 illustrates the Impact Test.

FIG. 16 illustrates the cell temperature profiles during the impact test for Cell #1 (baseline), #3, #5, and #6. The voltage of all tested cells dropped to zero as soon as the steel rod impact the cell. All cells with the resistive and gas-generator layer passed the test while the cell without any resistive layer failed in the test (caught the fire). The maximum cell temperature during the impact test is summarized in FIG. 17.

FIG. 17 summarizes the cell maximum temperature in the impact test for Cell #1 (baseline), #3, #4, #5, and #6.

FIG. 18 illustrates the cell voltage and temperature vs the impact testing time for Cell #6. The impact starting time was set to 2 minutes. The cell voltage dropped to zero as soon as the cell was impacted. The cell temperature is shown to increase rapidly.

FIG. 19 illustrates the cell voltage and temperature vs the overcharging time for Cell #1 (no any protection layer).

FIG. 20 illustrates the cell voltage and temperature vs the overcharging time for the cell with Cell #3 (CaCO₃ layer).

FIG. 21 illustrates the cell voltage and temperature vs the overcharging time for Cell #5 (Na₂O₇Si₃+Al₂O₃ layer).

FIG. 22 summarizes the cell maximum temperature in the over charge test (2 A/12V) for Cell #1 (baseline), #3, #4, #5, and #6.

FIG. 23 illustrates the cycle life of Cell #3 (CaCO₃ resistive layer). The cell lost about 1.8% after 100 cycles, which is lower than that of the cells without any resistive layer (˜2.5% by average, not shown).

FIG. 24 illustrates the cycle life of Cell #4 (CaCO₃ and Al₂O₃ resistive layer). The cell lost about 1.3% after 100 cycles, which is lower than that of the cells without any resistive layer (˜2.5% by average, not shown).

FIG. 25 illustrates the current profiles vs the voltage for compounds (gas generators) containing different anions for potential use in rechargeable batteries with different operation voltage.

FIG. 26 summarizes the peak current and voltage for compounds containing different anions.

FIG. 27 illustrates the current profiles vs the voltage for the polymers (organic gas generators) with or without different anions for potential use in rechargeable batteries with different operation voltage.

FIG. 28 summarizes the peak current and voltage for polymers with or without different anions.

FIG. 29 shows cell temperature and overcharge voltage profiles for the cell made with the positive containing gas generator and electrochemically active lithium nickel manganese cobalt oxide during 2 A/12V overcharge test at room temperature.

### DETAILED DESCRIPTION

Safe, long-term operation of high energy density rechargeable batteries, including lithium ion batteries, is a goal of battery manufacturers. One aspect of safe battery operation is controlling the heat generated by rechargeable batteries. As described above, many factors may cause the heat generated by a rechargeable battery to exceed its heat dissipation capacity, such as a battery defect, accident, or excessive internal current. When the heat generated by a battery exceeds its ability to dissipate heat, a rechargeable battery becomes susceptible to thermal runaway, overheating, and possibly even fire or violent explosion. Described below are apparatus and methods associated with a thermally activated internal current interrupter that can interrupt the internal circuit of a rechargeable battery, preventing thermal runaway.

A first aspect of the disclosure is directed to an improved high energy density rechargeable (HEDR) battery of a type including an anode energy layer, a cathode energy layer, a separator between the anode energy layer and the cathode energy layer for preventing internal discharge thereof, and at least one current collector for transferring electrons to and from either the anode or cathode energy layer. The anode and cathode energy layers each have an internal resistivity. The HEDR battery has a preferred temperature range for discharging electric current and an upper temperature safety limit. The improvement is employable, in the event of separator failure, for limiting the rate of internal discharge through the failed separator and the generation of joule heat resulting therefrom. More particularly, the improvement comprises a resistive layer interposed between the separator and one of the current collectors for limiting the rate of internal discharge through the failed separator in the event of separator failure. The resistive layer has a fixed resistivity at temperatures between the preferred temperature range and the upper temperature safety limit. The fixed resistivity of the resistive layer is greater than the internal resistivity of either energy layer. The resistive layer helps the battery avoid temperatures in excess of the upper temperature safety limit in the event of separator failure.

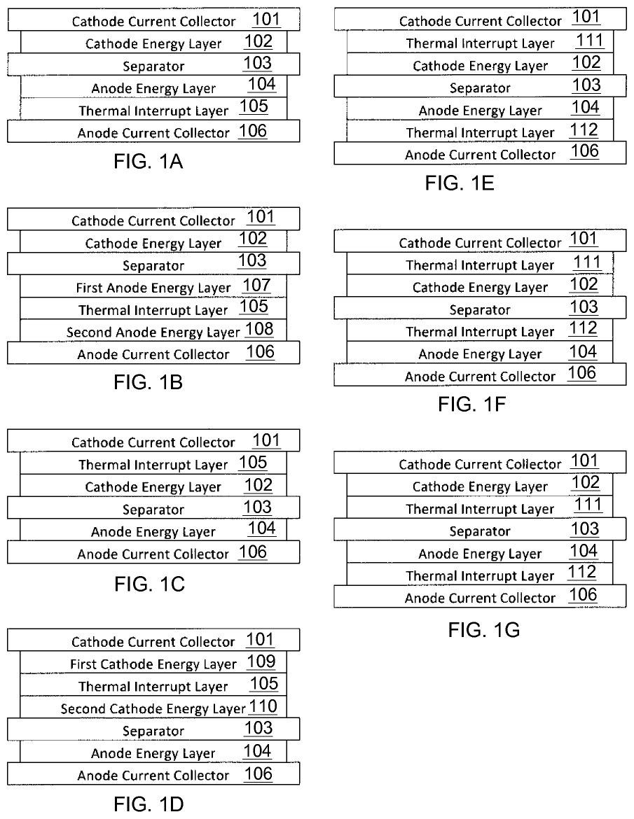

FIGS. 1A-1G illustrate schematic representations of exemplary configurations of film-type lithium ion batteries having one or more gas generating layers that serve as current interrupters for protecting the battery against overheating in the event of an internal short circuit. Gas generation is triggered by an elevation in temperature. The configurations of film-type lithium ion batteries shown in FIGS. 1A and 1C have a cathode current collector 101, a cathode energy layer 102, a separator 103, an anode energy layer 104, a thermal interrupt layer 105, and an anode current collector 106. The battery configuration shown in FIG. 1B has a cathode current collector 101, a cathode energy layer 102, a separator 103, a first anode energy layer 107, a second anode energy layer 108, a thermal interrupt layer 105 between the anode energy layers, and an anode current collector 106. The battery configuration shown in FIG. 1D has a cathode current collector 101, a first cathode energy layer 109, a second cathode energy layer 110, a thermal interrupt layer 105 between the cathode energy layers a separator 103, an anode energy layer 104, and an anode current collector 106. The battery configurations shown in FIGS. 1E-1G have a cathode current collector 101, a cathode energy layer 102, a separator 103, an anode energy layer 104, thermal interrupt layers 111 and 112, and an anode current collector 106. In the configurations shown in FIGS. 1E-1G, there is one thermal interrupt layer 111 between the cathode current collector 101 and the separator 103 and another thermal interrupt layer 112 between the separation 103 and the anode current collector 106.

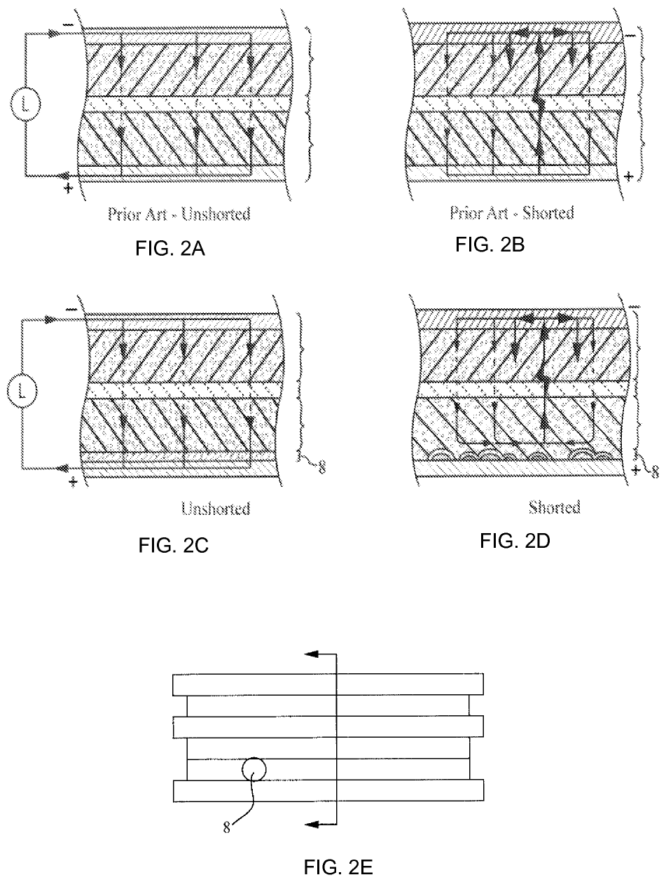

FIGS. 2A-2E illustrate cross sectional views of prior art film-type lithium ion batteries (FIGS. 2A and B) and of film-type lithium ion batteries with current interrupters, as described herein (FIGS. 2C and D). More particularly, FIGS. 2A-2E illustrate the current flow through film-type lithium ion batteries undergoing discharge for powering a load (L). FIGS. 2A and C illustrate the current flow of film-type lithium ion batteries having an intact fully operational separator (unshorted). FIGS. 2B and D illustrate the current flow of film-type lithium ion batteries having gas generating layers serving as current interrupters, wherein the separator has been short circuited by a conductive dendrite penetrating therethrough. In FIGS. 2B and D, the cells are undergoing internal discharge. Note that devices with unshorted separators (FIGS. 2A and C) and the prior art device with the shorted separator (FIG. 2B), current flows from one current collector to the other. However, in the exemplary battery, shown in FIG. 2E, having a shorted separator, the activated gas generating layer 8 (FIG. 2D) has delaminated from the current collector and the current flow is diverted from the current collector and is much reduced.

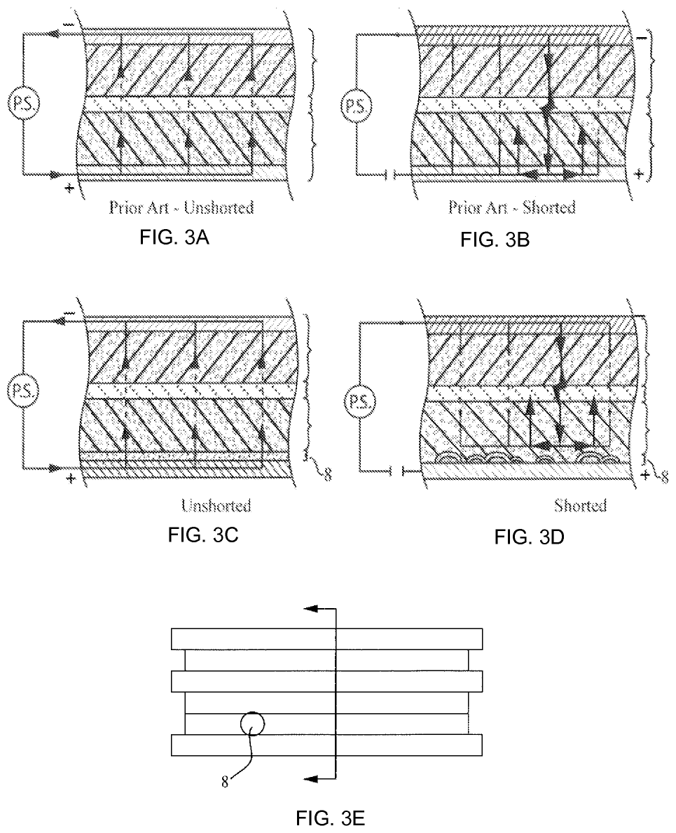

FIGS. 3A-3E illustrate cross sectional views of prior art film-type lithium ion batteries (FIGS. 3A and B) and of film-type lithium ion batteries with current interrupters, as described herein (FIGS. 3C and D). More particularly, FIGS. 3A-3E illustrate the current flow through film-type lithium ion batteries while its being charged by a smart power supply (PS) which will stop the charging when it detects any abnormal charge voltage. FIGS. 3A and C illustrate the current flow of film-type lithium ion batteries having an intact fully operational separator (unshorted). FIGS. 3B and D illustrate the current flow of film-type lithium ion batteries having gas generating layers serving as current interrupters, wherein the separator has been short circuited by a conductive dendrite penetrating therethrough. In FIGS. 3B and D, the cells are undergoing internal discharge. Note that devices with unshorted separators (FIGS. 3A and C) and the prior art device with the shorted separator (FIG. 3B), current flows from one current collector to the other. However, in the exemplary device, shown in FIG. 3E, having a shorted separator, the activated gas generating layer 8 (FIG. 3D) has delaminated from the current collector and the current flow is diverted from the current collector and is much reduced.

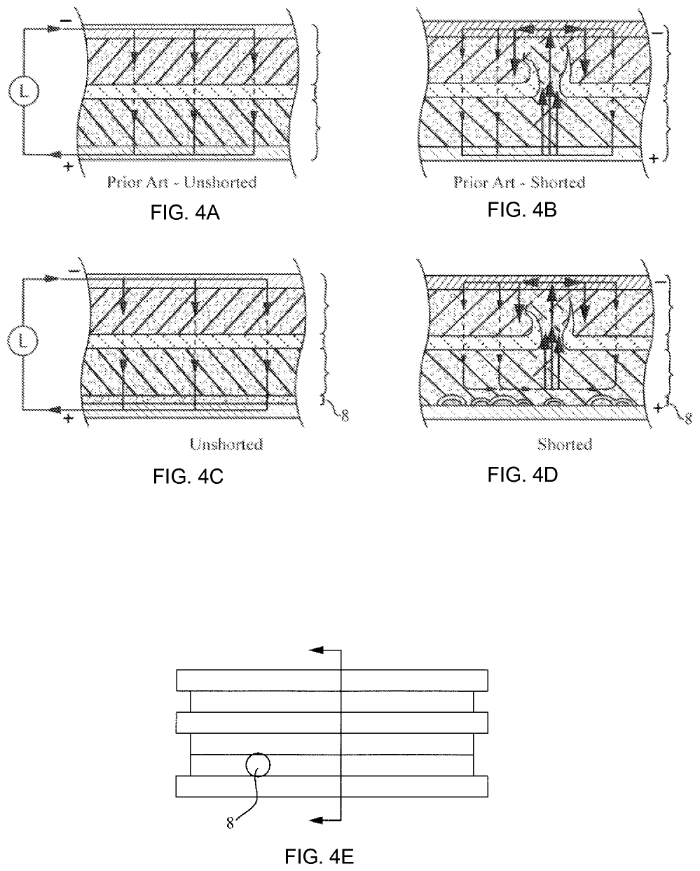

FIGS. 4A-4E illustrate cross sectional views of prior art film-type lithium ion batteries (FIGS. 4A and B) and of film-type lithium ion batteries with current interrupters, as described herein (FIGS. 4C and D). More particularly, FIGS. 4A-4E illustrate the current flow through film-type lithium ion batteries undergoing discharge for powering a load (L). FIGS. 4A and C illustrate the current flow of film-type lithium ion batteries having an intact fully operational separator (unshorted). FIGS. 4B and D illustrate the current flow of film-type lithium ion batteries having gas generating layers serving as current interrupters, wherein the separator has been short circuited by a conductive dendrite penetrating therethrough. In FIGS. 4B and D, the cells are undergoing internal discharge. Note that devices with unshorted separators (FIGS. 4A and C) and the prior art device with the shorted separator (FIG. 4B), current flows from one current collector to the other. However, in the exemplary device, shown in FIG. 4E, having a shorted separator, the activated gas generating layer 8 (FIG. 4D) has delaminated from the current collector and the current flow is diverted from the current collector and is much reduced.

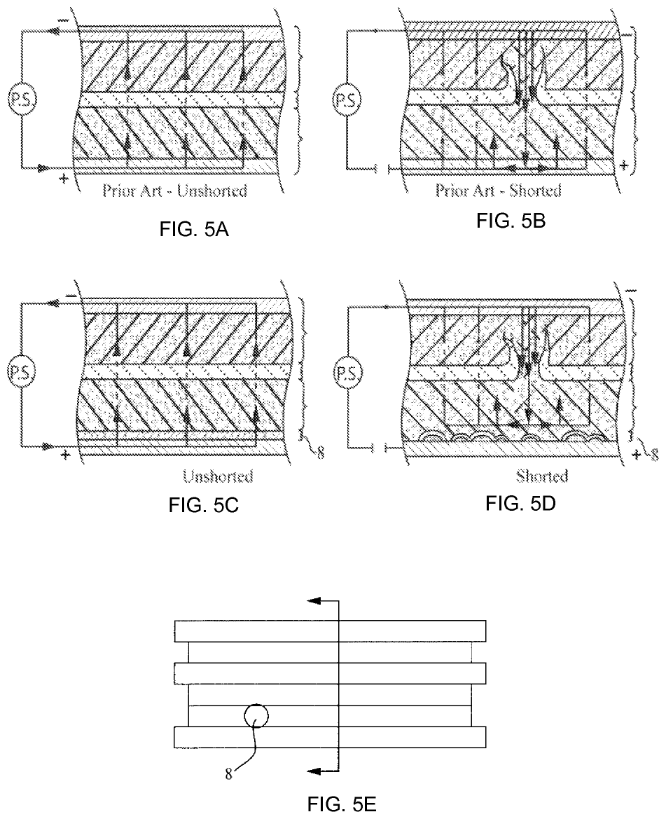

FIGS. 5A-5E illustrate cross sectional views of prior art film-type lithium ion batteries (FIGS. 5A and B) and of film-type lithium ion batteries with current interrupters, as described herein (FIGS. 5C and D). More particularly, FIGS. 5A-5E illustrate the current flow through film-type lithium ion batteries while its being charged by a power supply (PS) which will stop the charging when it detects any abnormal charging voltage. FIGS. 5A and C illustrate the current flow of film-type lithium ion batteries having an intact fully operational separator (unshorted). FIGS. 5B and D illustrate the current flow of film-type lithium ion batteries having gas generating layers serving as current interrupters, wherein the separator has been short circuited by a conductive dendrite penetrating therethrough. In FIGS. 5B and D, the cells are undergoing internal discharge. Note that devices with unshorted separators (FIGS. 5A and C) and the prior art device with the shorted separator (FIG. 5B), current flows from one current collector to the other. However, in the exemplary device, shown in FIG. 5E, having a shorted separator, the activated gas generating layer 8 (FIG. 5D) has delaminated from the current collector and the current flow is diverted from the current collector and is much reduced.

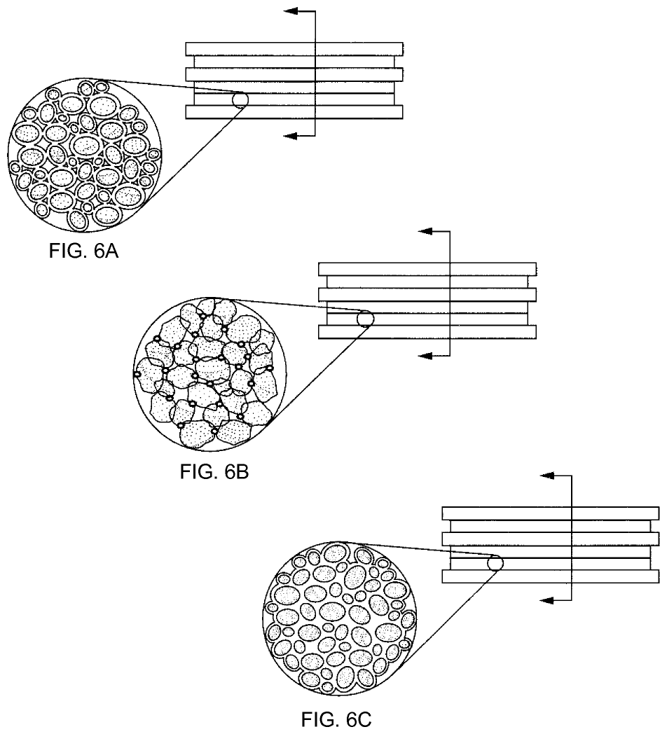

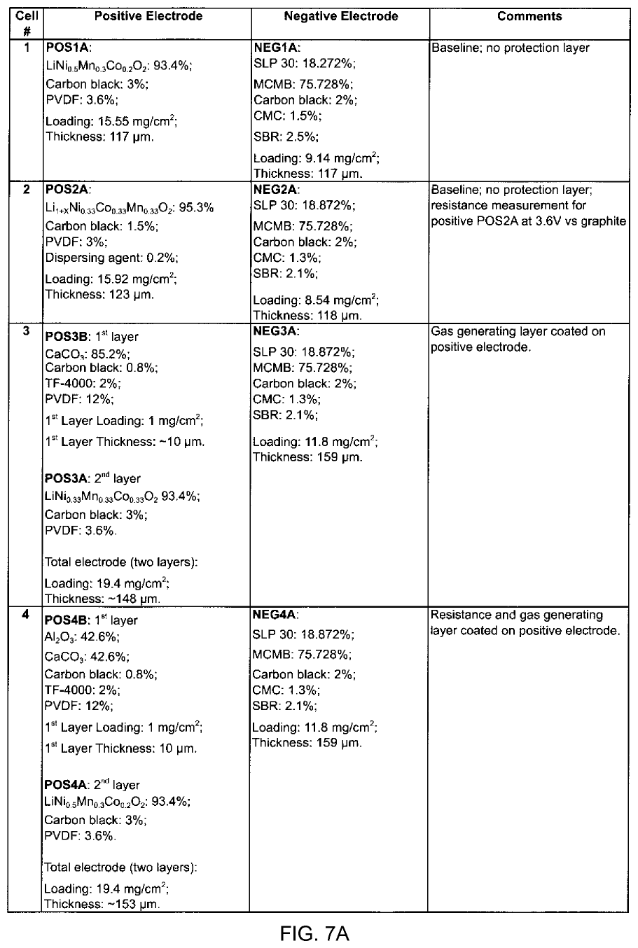

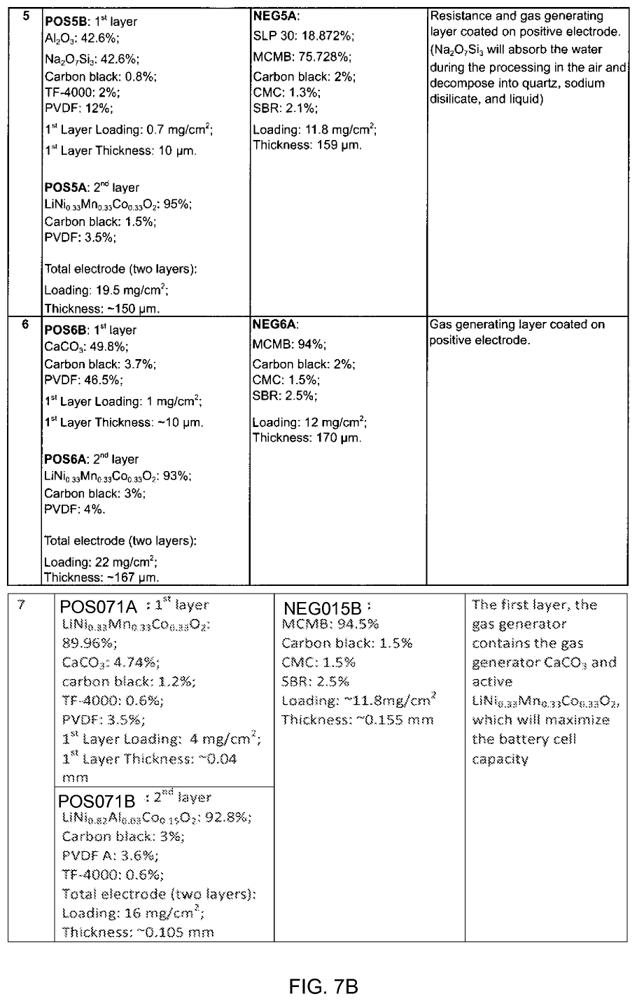

FIG. 6 illustrates exemplary structures for the gas generating layer (8). FIG. 6A illustrates resistive layer having a high proportion of ceramic particles coated with binder. Interstitial voids between the coated ceramic particles render the resistive layer porous. FIG. 6B illustrates resistive layer having a high proportion of ceramic particles (80% or more) bound together by particles of binder. Interstitial voids between the coated ceramic particles render the resistive layer porous. FIG. 6C illustrates resistive layer having an intermediate proportion of ceramic particles held together with binder. The resistive layer lacks interstitial voids between the coated ceramic particles and is non-porous.

The following abbreviations have the indicated meanings:
Carbopol®-934=cross-linked polyacrylate polymer supplied by Lubrizol
Advanced Materials, Inc.
CMC=carboxymethyl cellulose
CMC-DN-800H=CMC whose sodium salt of the carboxymethyl group had been replaced by ammonium (supplied by Daicel FineChem Ltd).
DEC=diethyl carbonate
EC=ethylene carbonate
EMC=ethyl-methyl carbonates
MCMB=mesocarbon microbeads
NMC=Nickel, Manganese and Cobalt
NMP=N-methylpyrrolidone
PTC=positive temperature coefficient
PVDF=polyvinylidene fluoride
SBR=styrene butadiene rubber
Super P®=conductive carbon blacks supplied by Timcal
Torlon® AI-50=water soluble analog of Torlon® 4000TF
Torlon® 4000TF=neat resin polyamide-imide (PAI) fine powder

Resistance layer and electrode active layer preparation and cell assembly for a high energy density rechargeable metal-ion battery are described below.

The general steps for preparation of a resistance layer (first layer) are listed below.
i. Dissolve the binder into an appropriate solvent.
ii. Add the conductive additive and ceramic powder into the binder solution to form a slurry.
iii. Coat the slurry made in Step ii. onto the surface of a metal foil, and then dry it to form a resistance layer on the surface of the foil.

The general steps for preparation of an electrode (on the top of the first layer) are listed below.
i. Dissolve the binder into an appropriate solvent.
ii. Add the conductive additive into the binder solution to form a slurry.
iii. Put the cathode or anode material into the slurry made in the Step v. and mix it to form the slurry for the electrode coating.
iv. Coat the electrode slurry made in the Step vi. onto the surface of the layer from Step iii.
v. Compress the electrode into the design thickness.

The general steps for cell assembly are as follows:
i. Dry the positive electrode at 125° C. for 10 hours and negative electrode at 140° C. for 10 hours.
ii. Punch the electrodes into the pieces with the electrode tab.
iii. Laminate the positive and negative electrodes with the separator as the middle layer.
iv. Put the flat jelly-roll made in the Step xi. into the Aluminum composite bag.

The Impact test (See FIG. 15) has the following steps:
i. Charge the cell at 2 A and 4.2V for 3 hr.
ii. Put the cell onto a hard flat surface such as concrete.
iii. Attach a thermal couple to the surface of the cell with high temperature tape and connect the positive and negative tabs to the voltage meter.
iv. Place a steel rod (15.8 mm+0.1 mm in diameter X about 70 mm long) on its side across the center of the cell.
v. Suspend a 9.1+0.46 Kg steel block (75 mm in diameter X 290 mm high) at a height of 610+25 mm above the cell.
vi. Using a containment tube (8 cm inside diameter) to guide the steel block, release the steel block through the tube and allow it to free fall onto the steel bar laying on the surface of the cell causing the separator to breach while recording the temperature.
vii. Leave the steel rod and steel block on the surface of the cell until the cell temperature stabilizes near room temperature.
viii. End test.

Overcharge test has the following steps:
i. Charge the cell at 2 A and 4.2V for 3 hr.
ii. Put the charged cell into a room temperature oven.
iii. Connect the cell to a power supply (manufactured by Hewlett-Packard).
iv. Set the voltage and current on the power supply to 12V and 2 A.
v. Turn on the power supply to start the overcharge test while recording the temperature and voltage.
vi. Test ends when the cell temperature decreases and stabilizes near room temperature.

The Resistance (Thermal) Measurement Test is as follows:
i. Place one squared copper foil (4.2×2.8 cm) with the tab on to a metal plate (˜12×˜8 cm). Then cut a piece of thermal tape and carefully cover one side of the squared copper foil.
ii. Cut a piece of the electrode that is slightly larger than the copper foil. Place the electrode on to the copper foil.
iii. Place another copper foil (4.2×2.8 cm) with tab on the electrode surface, repeat steps i-ii with it.
iv. At this point, carefully put them together and cover them using high temperature tape and get rid of any air bubble
v. Cut a “V” shaped piece of metal off both tabs.
vi. Attach the completed strip to the metal clamp and tighten the screws. Make sure the screws are really tight.
vii. Attach the tabs to the connectors of Battery HiTester (produced by Hioki USA Corp.) to measure the resistance to make sure that a good sample has been made for the measurement.
viii. Put the metal clamp inside the oven, connect the “V” shaped tabs to the connectors and then tightened the screw. Tape the thermal couple onto the metal clamp.
ix. Attach the Battery HiTester to the wires from oven. Do not mix up the positive and the negative wires.

x. Close the oven and set the temperature to 200° C. at 4° C. per minute, and start the test. Record data every 15 seconds.
xi. Stop recording the data when the metal clamp and oven reach just a little over 200° C.
xii. Turn off the oven and the Battery HiTester.
xiii. End Test.

The Cycle Life test procedure for a HEDR battery cell is as follows:
i. Rest for 5 minutes.
ii. Discharge to 2.8V.
iii. Rest for 20 minutes.
iv. Charge to 4.2V at 0.7 A for 270 minutes.
v. Rest for 10 minutes.
vi. Discharge to 2.8V at 0.7 A.
vii. Rest for 10 minutes.
viii. Repeat Steps iii to vii 100 times.
ix. End test.

Discharge test at 1 A, 3 A, 6 A, 10 A is described with the following steps. The battery cell is tested at a controlled temperature, for example 50° C.
i. Rest for 5 minutes.
ii. Discharge to 2.8V.
iii. Rest for 20 minutes.
iv. Charge to 4.2V at 0.7 A for 270 minutes.
v. Rest for 10 minutes.
vi. Discharge to 2.8V at 1 A.
vii. Rest for 10 minutes.
viii. Charge to 4.2V at 0.7 A for 270 minutes.
ix. Rest for 10 minutes.
x. Discharge to 2.8V at 3 A.
xi. Charge to 4.2V at 0.7 A for 270 minutes.
xii. Rest for 10 minutes.
xiii. Discharge to 2.8V at 6 A.
xiv. Charge to 4.2V at 0.7 A for 270 minutes.
xv. Rest for 10 minutes.
xvi. Discharge to 2.8V at 10 A.
xvii. Rest for 10 minutes.
xviii. End Test.

Unless defined otherwise, all technical and scientific terms used herein have the same meaning as is commonly understood by one of ordinary skill in the art to which this disclosure belongs. In the event that there is a plurality of definitions for a term herein, those in this section prevail unless stated otherwise.

As used herein, “high energy density rechargeable (HEDR) battery” means a battery capable of storing relatively large amounts of electrical energy per unit weight on the order of about 50 W-hr/kg or greater and is designed for reuse, and is capable of being recharged after repeated uses. Non-limiting examples of HEDR batteries include metal-ion batteries and metallic batteries.

As used herein, “metal-ion batteries” means any rechargeable battery types in which metal ions move from the negative electrode to the positive electrode during discharge and back when charging. Non-limiting examples of metal-ion batteries include lithium-ion, aluminum-ion, potassium-ion, sodium-ion, magnesium-ion, and others.

As used herein, “metallic batteries” means any rechargeable battery types in which the anode is a metal or metal alloy. The anode can be solid or liquid. Metal ions move from the negative electrode to the positive electrode during discharge and back when charging. Non-limiting examples of metallic batteries include M-S, M-NiCl₂, M-V₂O₅, M-Ag₂VP₂O₈, M-TiS₂, M-TiO₂, M-MnO₂, M-Mo₃S₄, M-MoS₆Se₂, M-MoS₂, M-MgCoSiO₄, M-Mg_{1.03}Mn_{0.97}SiO₄, and others, where M=Li, Na, K, Mg, Al, or Zn.

As used herein, “lithium-ion battery” means any rechargeable battery types in which lithium ions move from the negative electrode to the positive electrode during discharge and back when charging. Non-limiting examples of lithium-ion batteries include lithium cobalt oxide (LiCoO₂), lithium iron phosphate (LiFePO₄), lithium manganese oxide (LiMn₂O₄), lithium nickel oxide (LiNiO₂), lithium nickel manganese cobalt oxide (LiNiMnCoO₂), lithium nickel cobalt aluminum oxide (LiNiCoAlO₂), lithium titanate (Li₄Ti₅O₁₂), lithium titanium dioxide, lithium/graphene, lithium/graphene oxide coated sulfur, lithium-sulfur, lithium-purpurin, and others. Lithium-ion batteries can also come with a variety of anodes including silicon-carbon nanocomposite anodes and others. Lithium-ion batteries can be in various shapes including small cylindrical (solid body without terminals), large cylindrical (solid body with large threaded terminals), prismatic (semi-hard plastic case with large threaded terminals), and pouch (soft, flat body). Lithium polymer batteries can be in a soft package or pouch. The electrolytes in these batteries can be a liquid electrolyte (such as carbonate based or ionic), a solid electrolyte, a polymer based electrolyte or a mixture of these electrolytes.

As used herein, “aluminum-ion battery” means any rechargeable battery types in which aluminum ions move from the negative electrode to the positive electrode during discharge and back when charging. Non-limiting examples of aluminum-ion batteries include Al₂M2(XO₄)₃, wherein X=Si, P, S, Mo, As, and others; and M=Fe, Ca, Mg, V, Cr and others; aluminum transition-metal oxides (AlₓMO₂ wherein M=Fe, Mn, Ni, Mo, Co, Cr, Ti, V and others) such as Alₓ(V₄O₈), AlₓNiS₂, AlₓFeS₂, AlₓVS₂ and AlₓWS₂ and others.

As used herein, “potassium-ion battery” means any rechargeable battery types in which potassium ions move from the negative electrode to the positive electrode during discharge and back when charging. Non-limiting examples of potassium-ion batteries include KₙM₂(XO₄)₃, wherein X=Si, P, S, Mo, As, and others; and M=Fe, Ca, Mg, V, Cr and others; potassium transition-metal oxides (KMO₂ wherein M=Fe, Mn, Ni, Mo, Co, Cr, Ti, V and others), and others.

As used herein, “sodium-ion battery” means any rechargeable battery types in which sodium ions move from the negative electrode to the positive electrode during discharge and back when charging. Non-limiting examples of sodium -ion batteries include NaₙM₂(XO₄)₃, wherein X=Si, P, S, Mo, As, and others; and M=Fe, Ca, Mg, V, Cr and others; NaV₁₋ₓCrₓPO₄F, NaVPO₄F, Na₄Fe₃(PO₄)₂(P₂O₇), Na₂FePO₄F, Na₂FeP₂O₇, Na_{2/3}[Fe_{1/2}Mn_{1/2}]O₂, Na(Ni_{1/3}Fe_{1/3}Mn_{1/3})O₂, NaTiS₂, NaFeF₃; Sodium Transition-Metal Oxides (NaMO₂ wherein M=Fe, Mn, Ni, Mo, Co, Cr, Ti, V and others) such as Na_{2/3}[Fe_{1/2}Mn_{1/2}]O₂, Na(Ni_{1/3}Fe_{1/3}Mn_{1/3})O₂, NaₓMo₂O₄, NaFeO₂, Na_{0.7}CoO₂, NaCrO₂, NaMnO₂, Na_{0.44}MnO₂, Na_{0.7}MnO₂, Na_{0.7}MnO_{2.25}, Na_{2/3}Mn_{2/3}Ni_{1/3}O₂, Na_{0.61}Ti_{0.48}Mn_{0.52}O₂; Vanadium Oxides such as Na₁₊ₓV₃O₈, NaₓV₂O₅, and NaₓVO₂ (x=0.7, 1); and others.

As used herein, “magnesium-ion battery” means any rechargeable battery types in which magnesium ions move from the negative electrode to the positive electrode during discharge and back when charging. Non-limiting examples of magnesium-ion batteries include MgₙM₂(XO₄)₃, wherein X=Si, P, S, Mo, As, and others; and M=Fe, Ca, Mg, V, Cr and others; magnesium Transition-Metal Oxides (MgMO₂ wherein M=Fe, Mn, Ni, Mo, Co, Cr, Ti, V and others), and others.

As used herein, “silicon-ion battery” means any rechargeable battery types in which silicon ions move from the negative electrode to the positive electrode during discharge and back when charging. Non-limiting examples of silicon-ion batteries include SiₙM₂(XO₄)₃, wherein X=Si, P, S, Mo, As, and others; and M=Fe, Ca, Mg, V, Cr and others; Silicon Transition-Metal Oxides (SiMO₂ wherein M=Fe, Mn, Ni, Mo, Co, Cr, Ti, V and others), and others.

As used herein, “binder” means any material that provides mechanical adhesion and ductility with inexhaustible tolerance of large volume change. Non-limiting examples of binders include styrene butadiene rubber (SBR)-based binders, polyvinylidene fluoride (PVDF)-based binders, carboxymethyl cellulose (CMC)-based binders, poly(acrylic acid) (PAA)-based binders, polyvinyl acids (PVA)-based binders, poly(vinylpyrrolidone) (PVP)-based binders, and others.

As used herein, “conductive additive” means any substance that increases the conductivity of the material. Non-limiting examples of conductive additives include carbon black additives, graphite nonaqueous ultrafine carbon (UFC) suspensions, carbon nanotube composite (CNT) additives (single and multi-wall), carbon nano-onion (CNO) additives, graphene-based additives, reduced graphene oxide (rGO), conductive acetylene black (AB), conductive poly(3-methylthiophene) (PMT), filamentary nickel powder additives, aluminum powder, electrochemically active oxides such as lithium nickel manganese cobalt and others.

As used herein, “metal foil” means any metal foil that under high voltage is stable. Non-limiting examples of metal foils include aluminum foil, copper foil, titanium foil, steel foil, nano-carbon paper, graphene paper, carbon fiber sheet, and others.

As used herein, “ceramic powder” means any electrical insulator or electrical conductor that hasn't been fired. Non-limiting examples of ceramic powder materials include barium titanate (BaTiO₃), zirconium barium titanate, strontium titanate (SrTiO₃), calcium titanate (CaTiO₃), magnesium titanate (MgTiO₃), calcium magnesium titanate, zinc titanate (ZnTiO₃), lanthanum titanate (LaTiO₃), and neodymium titanate (Nd₂Ti₂O₇), barium zirconate (BaZrO₃), calcium zirconate (CaZrO₃), lead magnesium niobate, lead zinc niobate, lithium niobate (LiNbO₃), barium stannate (BaSnO₃), calcium stannate (CaSnO₃), magnesium aluminum silicate, sodium silicate (NaSiO₃), magnesium silicate (MgSiO₃), barium tantalate (BaTa₂O₆), niobium oxide, zirconium tin titanate, and others.

As used herein, “gas generator material” means any material which will thermally decompose to produce a fire retardant gas. Non-limiting examples of gas generator materials include inorganic carbonates such as Mₙ(CO₃)ₘ, Mₙ(SO₃)ₘ, Mₙ(NO₃)ₘ, ¹Mₙ²Mₙ(CO₃)ₘ, and others and organic carbonates such as polymethacrylic [—CH₂—C(CH₃)(COOM)—]ₚ and polyacrylate salts [—CH₂—CH(COOM)—]ₚ, and others wherein M, ¹M, ²M are independently selected from the group consisting of Ba, Ca, Cd, Co, Cu, Fe, K, Li, Mg, Mn, Na, Ni, Pb, Sr, and Zn; n is 1-3 and m is 1-4. In some embodiments, M is independently selected from the group consisting of an ammonium ion, pyridinium ion and a quaternary ammonium ion.

Layers were coated onto metal foils by an automatic coating machine (compact coater, model number 3R250W-2D) produced by Thank-Metal Co., Ltd. Layers are then compressed to the desired thickness using a calender machine (model number X15-300-1-DZ) produced by Beijing Sevenstar Huachuang Electronics Co., Ltd.

### EXAMPLES

### Example 1

Preparation of baseline electrodes, positive and negative electrodes, and the completed Cell #1 for the evaluation in the resistance measurement, discharge capability tests at 50° C., impact test, and cycle life test are described below.

### A) Preparation of POS1 A as an Example of the Positive Electrode Preparation

i) PVDF (21.6 g) was dissolved into NMP (250 g); ii) Carbon black (18 g) was added and mixed for 15 minutes at 6500 rpm; iii) LiNi_{0.5}Mn_{0.3}Co_{0.202} (NMC) (560.4 g) was added to the slurry from Step ii and mixed for 30 minutes at 6500 rpm to form a flowable slurry; iv) Some NMP was added for the viscosity adjustment; v) This slurry was coated onto 15 pm aluminum foil using an automatic coating machine with the first heat zone set to about 80° C. and the second heat zone to about 130° C. to evaporate off the NMP. The final dried solid loading was about 15.55 mg/cm². The positive layer was then compressed to a thickness of about 117 μm. The electrode made here was considered as zero voltage against a standard graphite electrode and was used for the impedance measurement at 0 V in relation to the temperature, and the dry for the cell assembly.

### B) Preparation of NEG2 A as an Example of the Negative Electrode Preparation

i) CMC (5.2 g) was dissolved into deionized water (˜300 g); ii) Carbon black (8.4 g) was added and mixed for 15 minutes at 6500 rpm; iii) Negative active graphite (JFE Chemical Corporation; Graphitized Mesophase Carbon Micro Bead (MCMB) and Synthetic Graphite (TIMCAL) (378.4 g in total) were added to the slurry from Step ii and mixed for 30 minutes at 6500 rpm to form a flowable slurry; iv) SBR (solid content 50% suspended in water) (16.8 g) was added to the slurry formed in Step iii and mixed at 6500 rpm for 5 min; v) The viscosity was adjusted for a smooth coating; vi) This slurry was coated onto 9μm thick copper foil using an automatic coating machine with the first heat zone set to about 70° C. and the second heat zone to about 100° C. to evaporate off the water. The final dried solid loading was about 9.14 mg/cm². The negative electrode layer was then compressed to a thickness of about 117 μm. The negative made was used for the dry for the cell assembly.

### C) Preparation of Cell for the Evaluation

i) The electrodes were punched into the pieces with an electrode tab; ii) The positive electrode was dried at 125° C. for 10 hours and negative electrode at 140° C. for 10 hours; iii) The positive and negative electrodes were laminated with the separator as the middle layer; iv) The jelly-roll made in the Step iii was laid flat into an aluminum composite bag; v) The bag from Step iv. was dried in a 70° C. vacuum oven; vi) The bag from Step v was filled with the LiPF6 containing organic carbonate based electrolyte; vii) The bag from Step vi was sealed; ix) Rest for 16 hours; ix) The cell was charged to 4.2V at C/20 rate for 5 hours and then to 4.2V at 0.5 C rate for 2 hours, then rest for 20 minutes, then discharged to 2.8V at 0.5 C rate. Under vacuum, the cell was punctured to release any gases and then resealed. The cell made here was used for grading and other tests such as discharging capability test at 50° C., impact test, cycle life test and so on.

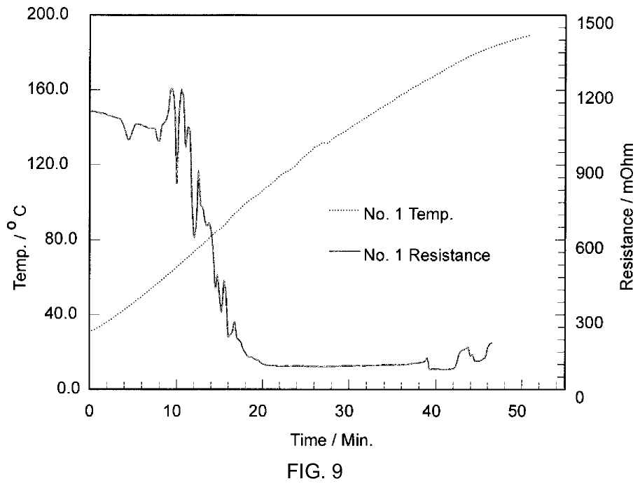

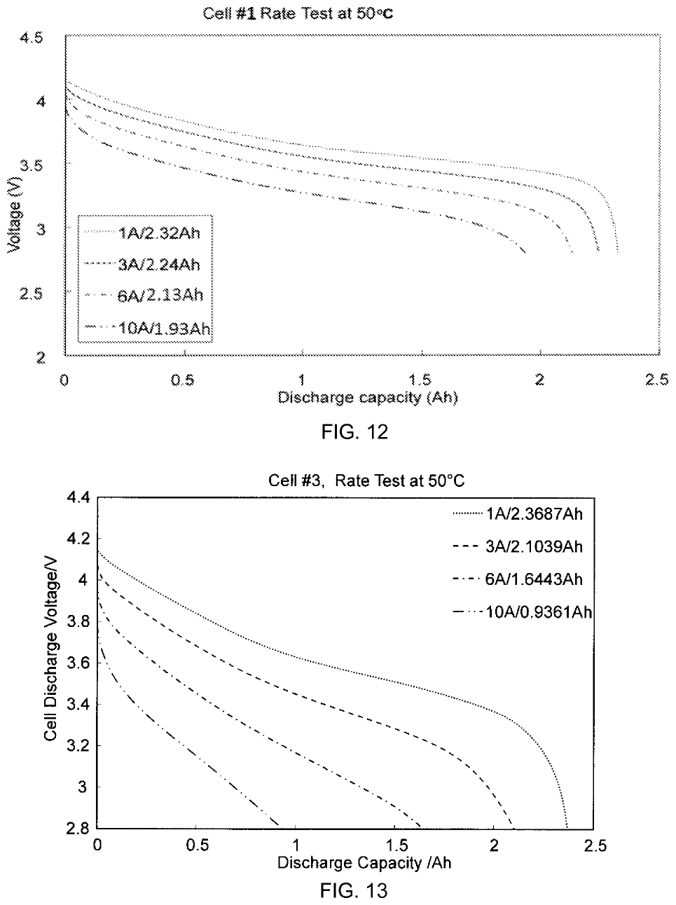

FIG. 9 presents the resistance in relation to the temperature increase for the positive electrode collected from autopsying a cell with 3.6 V. The resistance decreases about ten times. FIG. 12 shows the discharge capacity at the discharging currents 1, 3, 6, 10 A.

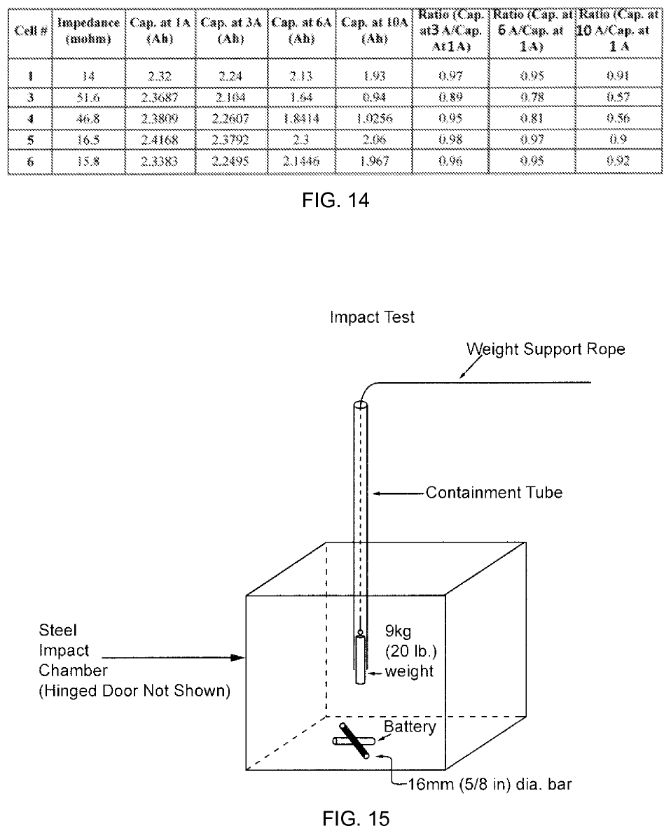

FIG. 14 lists the cell impedance at 1 kHz and the capacity at 1 A, 3 A, 6 A and 10 A currents and the ratio of the capacity at 3, 6, 10 A over that at 1 A. FIG. 14 summarizes the cell impedance and discharge capacities at 1 A, 3 A, 6 A and 10 A and their corresponding ration of the capacity at 3 A, 6 A or 10 A over that at 1 A for Cell #1 (baseline), #3, #4, #5, and #6. The cell impedance at 1 KHz goes up with the resistive and gas-generator layer. The resistive layer has caused the increase in the cell impedance since all cells with the resistive layer gets higher impedance while the cell discharge capacity depends on the individual case.

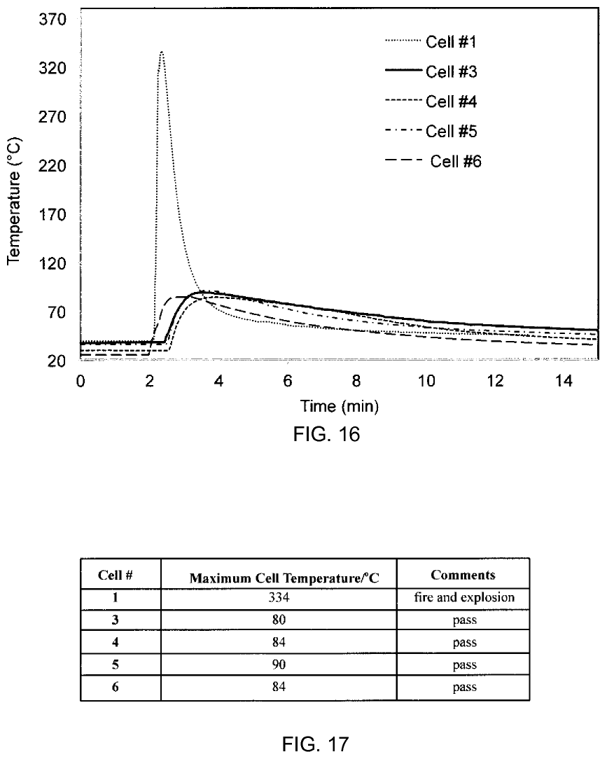

FIG. 16 shows the cell temperature profile during the impact test. FIG. 17 summarizes the cell maximum temperature in the impact test. The cell caught the fire during the impact test. FIG. 16 illustrates the cell temperature profiles during the impact test for Cell #1 (baseline), #3, #5, and #6. The voltage of all tested cells dropped to zero as soon as the steel rod impact the cell. All cells with the resistive and gas-generator layer passed the test while the cell without any resistive layer failed in the test (caught the fire). The maximum cell temperature during the impact test is summarized in FIG. 17.

FIG. 19 shows the voltage and temperature profiles of the cells during the 12V/2 A over charge test. The cell caught the fire during the over charge test. The cell voltage increased gradually up to 40 minutes and then decreased slightly and jumped to the maximum charge voltage rapidly at about 56 minutes while at the same time the cell temperature increased dramatically to above 600° C. The cell voltage and temperature then dropped to a very low value due to the connection being lost when the cell caught fire. The overcharge current was 2 A until the cell caught fire and then dropped to about 0.2 A for one or two minutes and then back to 2 A because the cell was shorted.

### Example 2

Preparation of CaCO₃ based gas generator and resistive layer, positive and negative electrodes, and the completed Cell #3 for the evaluation in the resistance measurement, discharge capability tests at 50° C., impact test, over charge, and cycle life test are described below.

### A) Positive POS3B as an Example of a Gas Generator and Resistive Layer (1^{st} Layer) Preparation

i) Torlon®4000TF (0.8 g) was dissolved into NMP (10 g); ii) PVDF (4.8 g) was dissolved into NMP (˜70 g); iii) The solutions prepared in Step i and ii were mixed, and then carbon black (0.32 g) was added and mixed for 10 minutes at 6500 rpm; iv) Nano CaCO3 powder (34.08 g) was added to the solution from Step iii and mixed for 20 minutes at 6500 rpm to form a flowable slurry; v) This slurry was coated onto 15 μm thick aluminum foil using an automatic coating machine with the first heat zone set to about 135° C. and the second heat zone to about 165° C. to evaporate off the NMP. The final dried solid loading was about 1 mg/cm².

### B) Preparation of POS3 A as an Example of the Positive Electrode Preparation (2^{nd} Layer)

i) PVDF (21.6 g) was dissolved into NMP (250 g); ii) Carbon black (18 g) was added and mixed for 15 minutes at 6500 rpm; iii) LiNi_{1/3}Co_{1/3}Mn_{1/3}O₂ (NMC) (560.4 g) was added to the slurry from Step ii and mixed for 30 minutes at 6500 rpm to form a flowable slurry; iv) Some NMP was added for the viscosity adjustment; v) This slurry was coated onto POS3B (Example 2 A) using an automatic coating machine with the first heat zone set to about 85° C. and the second heat zone to about 135° C. to evaporate off the NMP. The final dried solid loading was about 19.4 mg/cm². The positive layer was then compressed to a thickness of about 153 μm. The electrode made here was considered as zero voltage against a standard graphite electrode and was used for the impedance measurement at 0 V in relation to the temperature.

### C) Preparation of NEG3 A as an Example of the Negative Electrode Preparation

i) CMC (13 g) was dissolved into deionized water (˜1000 g); ii) Carbon black (20 g) was added and mixed for 15 minutes at the rate of about 6500 rpm; iii) Negative active graphite (JFE Chemical Corporation; Graphitized Mesophase Carbon Micro Bead (MCMB) and Synthetic Graphite (TIMCAL) (945.92 g in total) were added to the slurry from Step ii and mixed for 30 minutes at 6500 rpm to form a flowable slurry; iv) SBR (solid content 50% suspended in water) (42 g) was added to the slurry formed in Step iii and mixed at 6500 rpm for 5 min; v) The viscosity was adjusted for a smooth coating; vi) This slurry was coated onto 9 μm thick copper foil using an automatic coating machine with the first heat zone set to about 100° C. and the second heat zone to about 130° C. to evaporate off the water. The final dried solid loading was about 11.8 mg/cm². The negative electrode layer was then compressed to a thickness of about 159 μm. The negative made was used for the dry for the cell assembly.

### D) Preparation of Cell for the Evaluation

i) The electrodes were punched into the pieces with an electrode tab; ii) The positive electrode was dried at 125° C. for 10 hours and negative electrode at 140° C. for 10 hours; iii) The positive and negative electrodes were laminated with the separator as the middle layer; iv) The jelly-roll made in the Step iii was laid flat in an aluminum composite bag; v) The bag from Step iv was dried in a 70° C. vacuum oven; vi) The bag from Step v was filled with the LiPF6 containing organic carbonate based electrolyte; vii) The bag from Step vi was sealed; viii) Rest for 16 hours; ix) The cell was charged to 4.2V at C/50 rate for 8 hours and then to 4.2V at 0.5 C rate for 2 hours, then rest for 20 minutes, then discharged to 2.8V at 0.5 C rate; x) Under vacuum, the cell was punctured to release any gases and then resealed. The cell made here was used for grading and other tests such as discharging capability test at 50° C., impact test, cycle life test and so on.

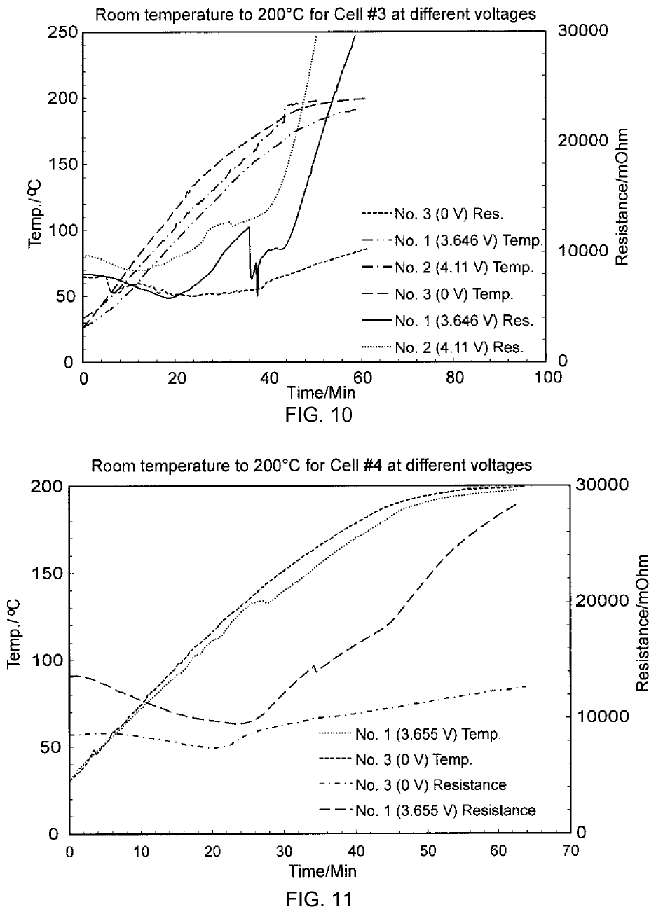

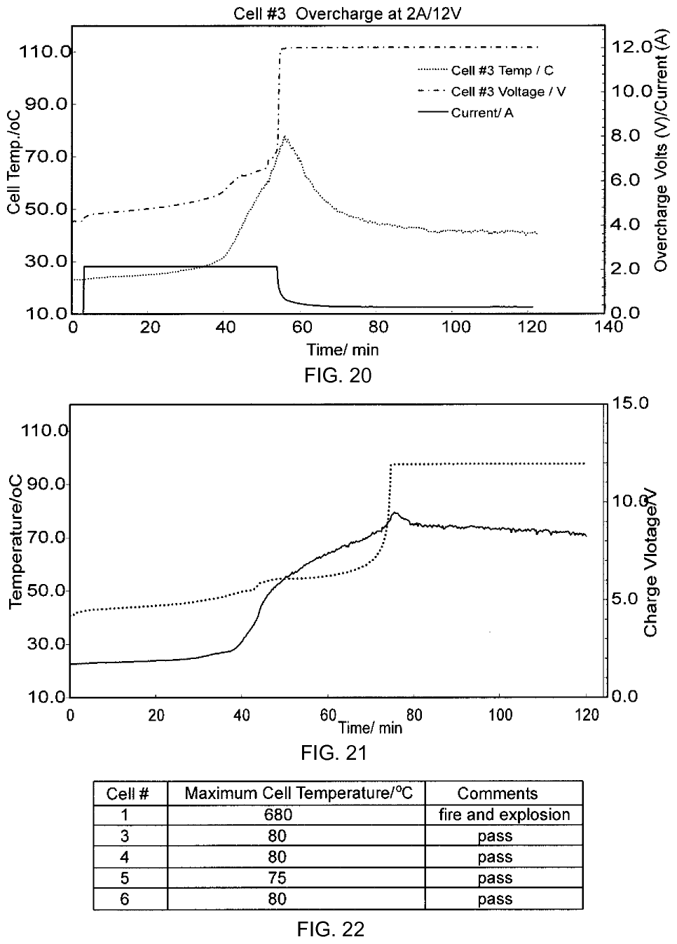

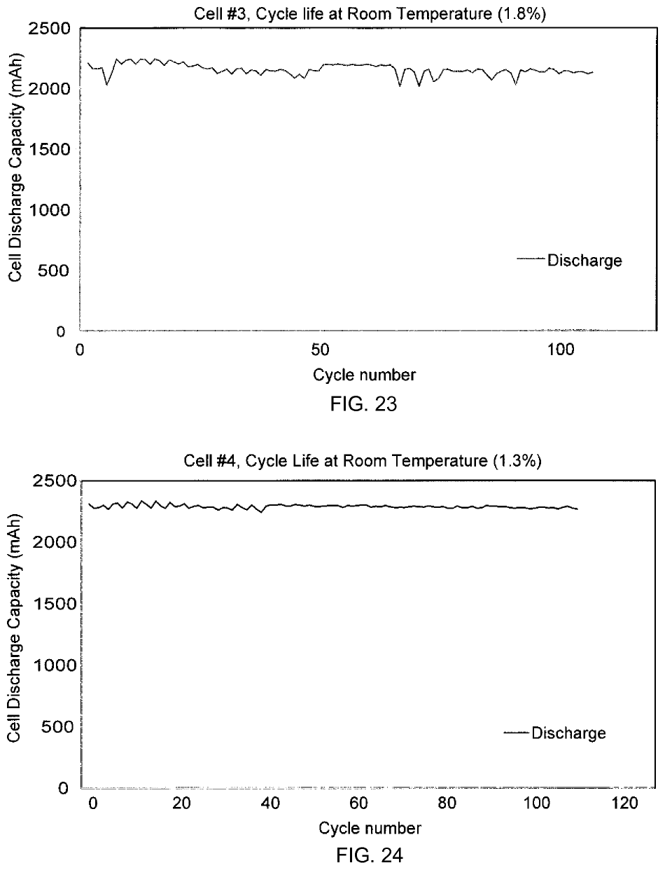

FIG. 10 presents the resistance in relation to the temperature increase for the positive electrode collected from autopsying cells with 0 V, 3.6 V, and 4.09 V. The resistance increases with the increase in the temperature, especially for the positive electrodes obtained from the cell having the voltages 3.66V and 4V. FIG. 13 shows the discharge capacity at 1 A, 3 A, and 6 A current and at 50° C. The cell capacity decreases significantly with the increase of the current, indicating the strong effect from the resistive layer. FIG. 14 lists the cell impedance at 1 kHz and the capacity at 1 A, 3 A, 6 A and 10 A currents and the ratio of the capacity at 3 A, 6 A, 10 A over that at 1 A. FIG. 20 presents the over charge profiles during the over charge test. FIG. 22 summarizes the cell maximum temperature during the over charge test and residual current in the end of over charge test. FIG. 23 shows the discharge capacity vs. the cycle number. The cell lost about 1% capacity that is about 100% better than that (2.5%) of the baseline cell. FIG. 16 shows the cell temperature profiles during the impact test. FIG. 17 summarizes the cell maximum temperature during the impact test.

### Example 3

Preparation of 50% Al₂O₃ and 50% CaCO₃ based gas generator and resistive layer, positive and negative electrodes, and the completed Cell #4 for the evaluation in the resistance measurement, discharge capability tests at 50° C., impact test, over charge and cycle life tests are described below.

### A) Positive POS4B as an Example of a Gas Generator and Resistive Layer (1^{st} Layer) Preparation

i) Torlon®4000TF (0.8 g) was dissolved into NMP (10 g); ii) PVDF (4.8 g) was dissolved into NMP (˜70 g); iii) The solutions prepared in Step i and ii were mixed, and then carbon black (0.32 g) was added and mixed for 10 minutes at 6500 rpm; iv) Nano CaCO₃ powder (17.04 g) and Al₂O₃ powder (17.04 g) were added to the solution from Step iii and mixed for 20 minutes at 6500 rpm to form a flowable slurry; v) This slurry was coated onto 15 μm thick aluminum foil using an automatic coating machine with the first heat zone set to about 135° C. and the second heat zone to about 165° C. to evaporate off the NMP. The final dried solid loading was about 1 mg/cm².

### B) Preparation of POS4 A as an Example of the Positive Electrode Preparation (2^{nd} Layer).

i) PVDF (21.6 g) was dissolved into NMP (250 g); ii) Carbon black (18 g) was added and mixed for 15 minutes at the rate of about 6500 rpm; iii) LiNi_{1/3}CO_{1/3}Mn_{1/3}O₂ (NMC) (560.4 g) was added to the slurry from Step ii and mixed for 30 minutes at 6500 rpm to form a flowable slurry; iv) Some NMP was added for the viscosity adjustment; v) This slurry was coated onto POS4B (Example 3 A) using an automatic coating machine with the first heat zone set to about 85° C. and the second heat zone to about 135° C. to evaporate off the NMP. The final dried solid loading was about 19.4 mg/cm². The positive layer was then compressed to a thickness of about 153 μm. The electrode made here was considered as zero voltage against a standard graphite electrode and was used for the impedance measurement at 0 V in relation to the temperature.

### C) Preparation of NEG4 A as an Example of the Negative Electrode Preparation

i) CMC (13 g) was dissolved into deionized water (˜1000 g); ii) Carbon black (20 g) was added and mixed for 15 minutes at 6500 rpm; iii) Negative active graphite (JFE Chemical Corporation; Graphitized Mesophase Carbon Micro Bead (MCMB) and Synthetic Graphite (TIMCAL) (945.92 g in total) were added to the slurry from Step ii and mixed for 30 minutes at 6500 rpm to form a flowable slurry; iv) SBR (solid content 50% suspended in water) (42 g) was added to the slurry formed in Step iii and mixed at about 6500 rpm for 5 min; v) The viscosity was adjusted for a smooth coating; vi) This slurry was coated onto 9 μm thick copper foil using an automatic coating machine with the first heat zone set to about 100° C. and the second heat zone to about 130° C. to evaporate off the water. The final dried solid loading was about 11.8 mg/cm². The negative electrode layer was then compressed to a thickness of about 159 μm. The negative made was used for the dry for the cell assembly.

### D) Preparation of Cell for the Evaluation

i) The electrodes were punched into the pieces with an electrode tab; ii) The positive electrode was dried at 125° C. for 10 hours and negative electrode at 140° C. for 10 hours; iii) The positive and negative electrodes were laminated with the separator as the middle layer; iv) The jelly-roll made in the Step iii was laid flat in an aluminum composite bag; v) The bag from Step iv was dried in a 70° C. vacuum oven; vi) The bag from Step v was filled with the LiPF₆ containing organic carbonate based electrolyte; vii) The bag from Step vi was sealed; viii) Rest for 16 hours; ix) The cell was charged to 4.2V at C/50 rate for 8 hours and then to 4.2V at 0.5 C rate for 2 hours, then rest for 20 minutes, then discharged to 2.8V at 0.5 C rate; x) Under vacuum, the cell was punctured to release any gases and then resealed. The cell made here was used for grading and other tests such as discharging capability test at 50° C., impact test, cycle life test and so on.

FIG. 14 lists the cell impedance at 1 kHz and the capacity at 1 A, 3 A, 6 A and 10 A currents and the ratio of the capacity at 3, 6, and 10 A over that at 1 A. FIG. 16 shows the cell temperature profiles during the impact test. FIG. 17 summarizes the cell maximum temperature in the impact test.

FIG. 20 shows the voltage profiles of the cell voltage and temperature during the 12V/2 A over charge test. The cell voltage increased gradually up to 40 minutes and then rapidly increased to a maximum charge voltage of 12V at about 55 minutes. The cell temperature rapidly increased to above 80° C. starting at about 40 minutes and then decreased rapidly. The over charge current decreased significantly at 55° C. and kept to 0.2 A for the rest of the testing time. The cell swelled significantly after the test.

FIG. 22 summarizes the cell maximum cell temperatures in the over charge test.

### Example 4

Preparation of Al₂O₃ and Sodium trisilicate (NaSiO₃) mixed based gas generator and resistive layer, positive and negative electrodes, and the completed Cell #5 for the evaluation in the resistance measurement, discharge capability tests at 50° C., impact test, over charge, and cycle life tests are described below.

### A) Positive POS5B as an Example of a Gas Generator and Resistive Layer (1^{st} Layer) Preparation.

i) Torlon®4000TF (0.8 g) was dissolved into NMP (˜10 g); ii) PVDF (4.8 g) was dissolved into NMP (60 g); iii) The solutions prepared in Step i and ii were mixed, and then carbon black (0.32 g) was added and mixed for 10 minutes at 6500 rpm; iv) Nano Al₂O₃ powder (17.04 g) and NaSiO3 (17.04 g) were added to the solution from Step iii and mixed for 20 minutes at 6500 rpm to form a flowable slurry; v) This slurry was coated onto 15 μm thick aluminum foil using an automatic coating machine with the first heat zone set to about 135° C. and the second heat zone to about 165° C. to evaporate off the NMP. The final dried solid loading was about 0.7 mg/cm².

### B) Preparation of POS5 A as an Example of the Positive Electrode Preparation (2^{nd} Layer)

i) PVDF (21.6 g) was dissolved into NMP (270 g); ii) Carbon black (18 g) was added and mixed for 15 minutes at the rate of about 6500 rpm; iii) LiNi_{1/3}Co_{1/3}Mn_{1/3}O₂ (NMC) (560.4 g) was added to the slurry from Step ii and mixed for 30 minutes at the rate of about 6500 rpm to form a flowable slurry; iv) Some NMP was added for the viscosity adjustment; v) This slurry was coated onto POS5B (Example 4 A) using an automatic coating machine with the first heat zone set to about 85° C. and the second heat zone to about 135° C. to evaporate off the NMP. The final dried solid loading was about 19.4 mg/cm². The positive layer was then compressed to a thickness of about 153 μm. The electrode made here was considered as zero voltage against a standard graphite electrode and was used for the impedance measurement at 0 V in relation to the temperature.

### C) Preparation of NEG5 A as an Example of the Negative Electrode Preparation

i) CMC (13 g) was dissolved into deionized water (˜1000 g); ii) Carbon black (20 g) was added and mixed for 15 minutes at the rate of about 6500 rpm; iii) Negative active graphite (JFE Chemical Corporation; Graphitized Mesophase Carbon Micro Bead (MCMB) and Synthetic Graphite (TIMCAL) (945.92 g in total) were added to the slurry from Step ii and mix for 30 minutes at 6500 rpm to form a flowable slurry; iv) SBR (solid content 50% suspended in water) (42 g) was added to the slurry formed in Step iii and mixed at 6500 rpm for 5 min; v) The viscosity was adjusted for a smooth coating; vi) This slurry was coated onto 9 μm thick copper foil using an automatic coating machine with the first heat zone set to about 100° C. and the second heat zone to about 130° C. to evaporate off the water. The final dried solid loading was about 11.8 mg/cm². The negative electrode layer was then compressed to a thickness of about 159 μm. The negative made is ready for the dry for the cell assembly.

### D) Preparation of Cell for the Evaluation

i) The electrodes were punched into the pieces with an electrode tab; ii) The positive electrode was dried at 125° C. for 10 hours and negative electrode at 140° C. for 10 hours; iii) The positive and negative electrodes were laminated with the separator as the middle layer; iv) The jelly-roll made in the Step iii was laid flat in an aluminum composite bag; v) The bag from Step iv. was dried in a 70° C. vacuum oven; vi) The bag from Step v was filled with the LiPF₆ containing organic carbonate based electrolyte; vii) The bag from Step vi was sealed; viii) Rest for 16 hours; ix) The cell was charged to 4.2V at C/50 rate for 8 hours and then to 4.2V at 0.5 C rate for 2 hours, then rest for 20 minutes, then discharged to 2.8V at 0.5 C rate. x) Under vacuum, the cell was punctured to release any gases and then resealed. The cell made here was used for grading and other tests such as discharging capability test at 50° C., impact test, cycle life test and so on.

FIG. 12 lists the cell impedance at 1 kHz and the capacity at 1 A, 3 A, 6 A and 10 A currents and the ratio of the capacity at 3, 6, and 10 A over that at 1 A. FIG. 16 shows the cell temperature profiles during the impact test FIG. 17 summarizes the cell maximum temperature in the impact test. FIG. 22 summarizes the cell maximum temperature in the 12V/2 A overcharge test.

FIG. 21 illustrates the cell voltage and temperature vs the overcharging time for Cell #5 (Na₂O₇Si₃+Al₂O₃ layer). The cell voltage increased gradually up to 40 minutes and then rapidly increased to a maximum charge voltage 12V at about 75 minutes. The cell overcharge voltage profiles is very different from CaCO₃ base resistive layer, which indicates the difference in the decomposition of Na₂O₇Si₃ compared with that of CaCO₃. The cell temperature increased significantly at about 40 minutes to above 75° C. and then decreased gradually. The over charge current decreased significantly at 75 minutes and kept to 1 A for the rest of the testing time. The cell swelled significantly after the test.

### Example 5

Preparation of 52% CaCO₃ and 48% PVDF based gas generator and resistive layer, positive and negative electrodes, and the completed Cell #6 for the evaluation in the resistance measurement, discharge capability tests at 50° C., impact test, over charge, and cycle life tests are discussed below.

### A) Positive POS6B as an Example of a Gas Generator and Resistive Layer (1^{st} Layer) Preparation

i) PVDF (23.25 g) was dissolved into NMP (˜250 g); ii) The solution prepared in Step I was mixed, and then carbon black (1.85 g) was added and mixed for 10 minutes at the rate of about 6500 rpm; iv) Nano CaCO₃ powder (24.9 g) was added to the solution from Step iii and mixed for 20 minutes at 6500 rpm to form a flowable slurry; v) This slurry was coated onto 15 μm thick aluminum foil using an automatic coating machine with the first heat zone set to about 135° C. and the second heat zone to about 165° C. to evaporate off the NMP. The final dried solid loading was about 1 mg/cm².

### B) Preparation of POS6 A as an Example of the Positive Electrode Preparation (2^{nd} Layer)

i) PVDF (24 g) was dissolved into NMP (300 g); ii) Carbon black (12 g) was added and mixed for 15 minutes at 6500 rpm; iii) LiNi_{0.4}Co_{0.3}Mn_{0.4}Co_{0.3}O₂ (NMC) (558 g) was added to the slurry from Step ii and mixed for 30 minutes at 6500 rpm to form a flowable slurry; iv) Some NMP was added for the viscosity adjustment; v) This slurry was coated onto POS6B (Example 5 A) using an automatic coating machine with the first heat zone set to about 85° C. and the second heat zone to about 135° C. to evaporate off the NMP. The final dried solid loading was about 22 mg/cm². The positive layer was then compressed to a thickness of about 167 μm. The electrode made here was considered as zero voltage against a standard graphite electrode and was used for the impedance measurement at 0 V in relation to the temperature.

### C) Preparation of NEG6 A as an Example of the Negative Electrode Preparation

i) CMC (9 g) was dissolved into deionized water (˜530 g); ii) Carbon black (12 g) was added and mixed for 15 minutes at 6500 rpm; iii) Negative active graphite (JFE Chemical Corporation; Graphitized Mesophase Carbon Micro Bead (MCMB) (564 g) were added to the slurry from Step ii and mixed for 30 minutes at 6500 rpm to form a flowable slurry; iv) SBR (solid content 50% suspended in water) (30 g) was added to the slurry formed in Step iii and mixed at about 6500 rpm for 5 min; v) Some water was added to adjust the viscosity for a smooth coating; vi) This slurry was coated onto 9 μm thick copper foil using an automatic coating machine with the first heat zone set to about 95° C. and the second heat zone to about 125° C. to evaporate off the water. The final dried solid loading was about 12 mg/cm². The negative electrode layer was then compressed to a thickness of about 170 μm. The negative made was used for the dry for the cell assembly.

### D) Preparation of Cell for the Evaluation

i) The electrodes were punched into the pieces with an electrode tab; ii) The positive electrode was dried at 125° C. for 10 hours and negative electrode at 140° C. for 10 hours; iii) The positive and negative electrodes were laminated with the separator as the middle layer; iv) The jelly-roll made in the Step iii was laid flat in an aluminum composite bag; v) The bag from Step iv was dried in a 70° C. vacuum oven; vi) The bag from Step v was filled with the LiPF₆ containing organic carbonate based electrolyte; vii) The bag from Step vi was sealed; viii) Rest for 16 hours; ix) The cell was charged to 4.2V at C/50 rate for 8 hours and then to 4.2V at 0.5 C rate for 2 hours, then rest for 20 minutes, then discharged to 2.8V at 0.5 C rate. x) Under vacuum, the cell was punctured to release any gases and then resealed. The cell made here was used for grading and other tests such as discharging capability test at 50° C., impact test, cycle life test and so on.

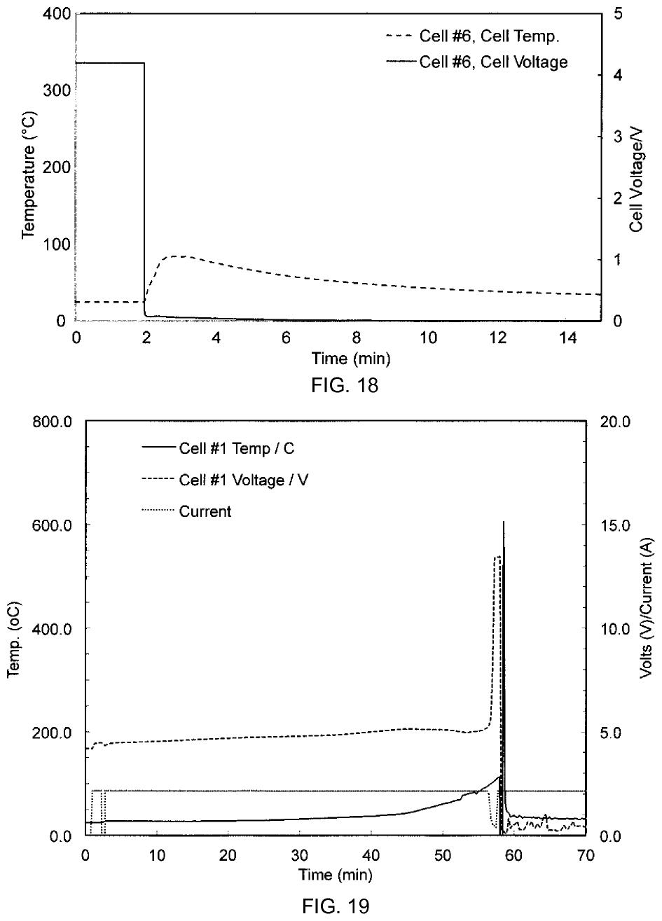

FIG. 14 lists the cell impedance at 1 kHz and the capacity at 1 A, 3 A, 6 A and 10 A currents and the ratio of the capacity at 3 A, 6 A, 10 A over that at 1 A. FIG. 16 shows the cell temperature profiles during the impact test. FIG. 17 summarizes the cell maximum temperature in the impact test. FIG. 22 summarizes the cell maximum cell temperatures in the over charge test. FIG. 18 illustrates the cell voltage and temperature vs the impact testing time for Cell #6. The impact starting time was set to 2 minutes. The cell voltage dropped to zero as soon as the cell was impacted. The cell temperature is shown to increase rapidly.

### Example 6

Preparation of positive electrodes for chemical decomposition voltage measurements is described below.

POS7B was prepared as follows: (i) Deionized water (˜300 g) was mixed into Carbopol®-934 (19.64 g); (ii) Super-® (160 mg) and LiOH (200 mg) were added into the slurry made in Step (i) and mixed for 30 minutes at 5000 rpm; (iii) An appropriate amount of deionized water was added to adjust the slurry to form a coatable slurry. (iv) The slurry was coated onto a 15 μm aluminum foil with the automatic coating machine with the drying temperatures set to 135° C. for zone 1 and 165° C. for zone 2. The final dried solid loading was about 0.7 mg/cm².

POS8B was prepared as follows: (i) Deionized water (˜100 g) was mixed into AI-50 (19.85 g); (ii) Super-P® (160 mg) was added into the slurry made in Step (i) and mixed for 30 minutes at 5000 rpm; (iii) An appropriate amount of deionized water was added to adjust the slurry to form a coatable slurry. (iv) The slurry was coated onto 15 μm aluminum foil with automatic coating machine with the drying temperatures set to 135 for zone 1 and 165° C. for zone 2. The final dried solid loading was about 0.7 mg/cm².

POS9B was prepared as follows: (i) Deionized water (˜322 g) was mixed into 19.85 g CMC-DN-800H; (ii) Super-P® (160 mg) was added into the slurry made in Step (i) and mixed for 30 minutes at 5000 rpm; (iii) An appropriate amount of deionized water was added to adjust the slurry to form a coatable slurry. (iv) The slurry was coated onto 15 μm aluminum foil with automatic coating machine with the drying temperatures set to 135 for zone 1 and 165° C. for zone 2. The final dried solid loading was about 0.7 mg/cm².

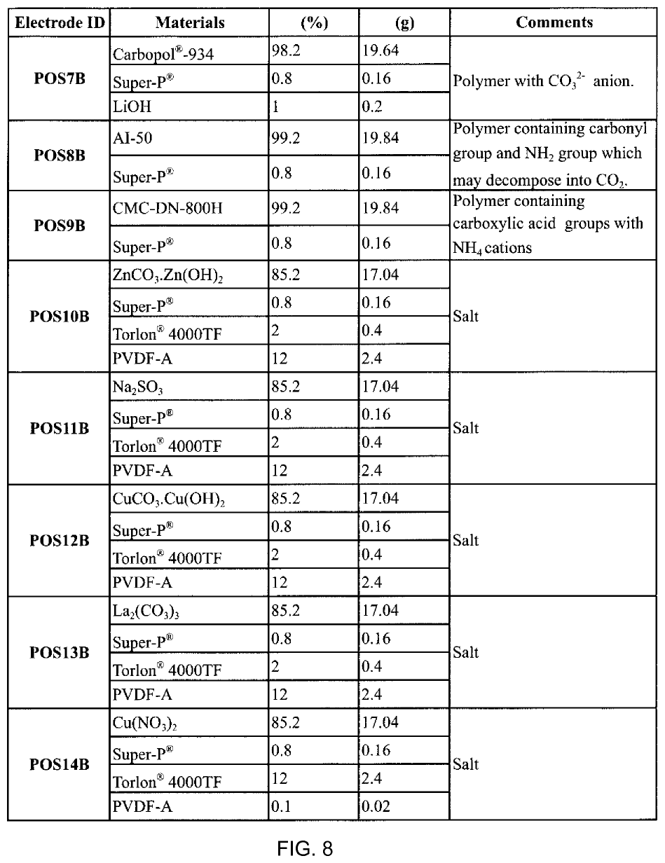

POS13B was prepared as follows: (i) Torlon 4000TF (400 mg) was dissolved into NMP (4 g). (ii) PVDF-A (2.4 g) was dissolved into NMP (30 g). (iii) The two solutions were mixed and Super-P® (160 mg) was added, then mixed for 30 minutes at 5000 rpm. (iv) La₂(CO₃)₃ (17.04 g) or the salts listed in FIG. 8 were added into above slurry and mixed together at 5000 rpm for 30 min. (v) The slurry was coated onto 15 μm aluminum foil with automatic coating machine at first heat zone set to 13° C. and second heat zone to 16° C. for evaporate off the NMP. Final dried solid loading was about 0.7 mg/cm².

### Example 7

Electrochemical test for the positives electrodes coated with gas generator layers is described below.

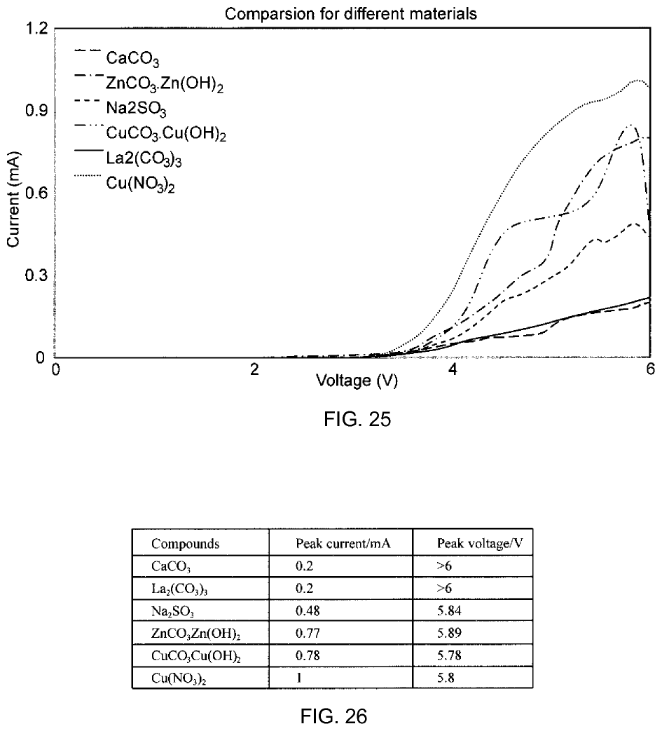

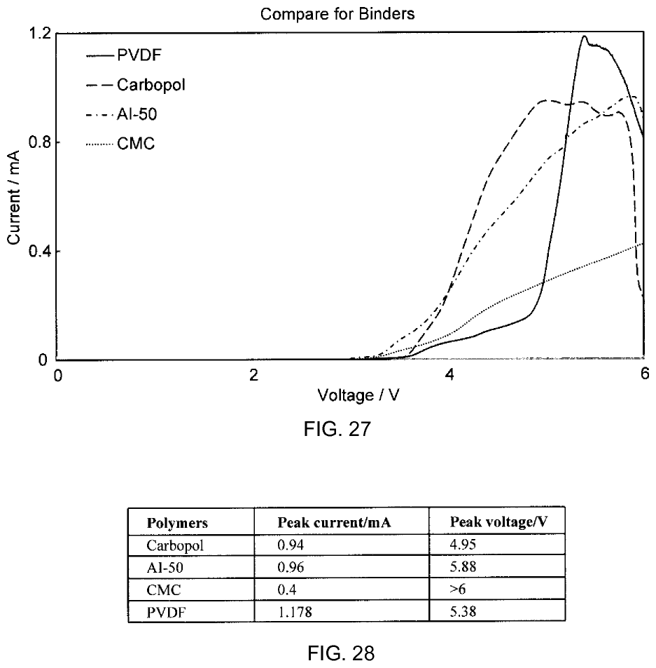

The decomposition voltages of all resistive layers were measured with a three electrode configuration (resistive layer as the working electrode, and lithium metal as both reference electrode and count electrode) by Linear Sweep Voltammetry technology using a VMP2 multichannel potentiostat instrument at room temperature. A 0.3 cm×2.0 cm piece of the resistive layer was the working electrode, and 0.3 cm×2.0 cm piece of lithium metal was both reference electrode and counter electrode. These electrodes were put into a glass containing LiPF₆ ethylene carbonate based electrolyte (5 g). The scan rate is 5 mV/second in the voltage range from 0 to 6V. FIGS. 25 and 27 shows the decomposition voltage profiles of these compounds. FIGS. 26 and 28 summarizes the peak current and peak voltage for each of the compounds tested.

FIG. 25 illustrates the current profiles vs the voltage for compounds (gas generators) containing different anions for potential use in rechargeable batteries with different operation voltage. The peak current and voltages are listed in FIG. 26. The peak current for Cu(NO₃)₂ was the highest while the peak current for CaCO₃ was the lowest. The peak voltage for Cu(NO₃)₂ was the lowest while the peak voltage of CaCO₃ was the highest. Therefore, Cu(NO₃)₂ may be useful in lithium ion batteries with a relatively low operation voltage such as lithium ion cell using lithium iron phosphate positive electrode (3.7 V as the typical maximum charging voltage). CaCO₃ may be useful in lithium ion batteries with a high operation voltage like lithium ion cell using the high voltage positive such as lithium cobalt oxide (4.2V as the typical maximum charging voltage) or lithium nickel cobalt manganese oxides (4.3 or 4.4V as the typical high charging voltage).

FIG. 27 illustrates the current profiles vs the voltage for the polymers (organic gas generators) with or without different anions for potential use in rechargeable batteries with different operation voltage. PVDF is included as the reference. The peak current and voltages are listed in FIG. 28. The peak current for Carbopol, AI-50 and PVDF were very similar while CMC was the lowest. The peak voltage of Carbopol was the lowest while the CMC peak voltage was the highest. Therefore, Carbopol containing CO₃²⁻ anion may be useful in lithium ion batteries with a relatively low operation voltage such as lithium ion cell using lithium iron phosphate positive electrode (3.7 V as the typical maximum charging voltage). CMC may be useful in lithium ion batteries with a high operation voltage like lithium ion cell using a high voltage positive such as lithium cobalt oxide (4.2V as the typical maximum charging voltage) or lithium nickel cobalt manganese oxides (4.3 or 4.4V as the typical high charging voltage). Water is one of CMC's decomposition compounds and will become vapor or gas above 100° C.

### Example 8

Preparation of CaCO₃ based gas generator layer, positive and negative electrodes, and the cell (#7) for the evaluation in the over charge test is described below.

### A) Positive POS071 A as an Example of a Gas Generator Layer (1^{st} Layer) Preparation

i) Torlon 4000TF (0.9 g) was dissolved into NMP (10 g); ii) PVDF (5.25 g) was dissolved into NMP (˜68 g); iii) The solutions prepared in Step i and ii were mixed, and then carbon black (1.8 g) was added and mixed for 10 min at the rate of about 6500 rpm; iv) Nano CaCO3 powder (7.11 g) and 134.94 g LiNi_{0.33}Mn_{0.33}Co_{0.33}O₂ were added to the solution from Step iii and mixed for 20 min at the rate of about 6500 rpm to form a flowable slurry; v) This slurry was coated onto 15 μm thick aluminum foil using an automatic coating machine with the first heat zone set to about 90° C. and the second heat zone to about 140° C. to evaporate off the NMP. The final dried solid loading was about 4 mg/cm².

### B) Preparation of POS071B as an Example of the Positive Electrode Preparation (2^{nd} Layer)

i) PVDF (25.2 g) was dissolved into NMP (327 g); ii) Carbon black (21 g) was added and mixed for 15 min at the rate of about 6500 rpm; iii) LiNi_{0.82} Al_{0.03}Co_{0.15}O₂ (NCA) (649 g) was added to the slurry from Step ii and mixed for 30 min at the rate of about 6500 rpm to form a flowable slurry; iv) Some NMP was added for the viscosity adjustment; v) This slurry was coated onto POS071 A using an automatic coating machine with the first heat zone set to about 85° C. and the second heat zone to about 135° C. to evaporate off the NMP. The final dried solid loading is about 20.4 mg/cm². The positive layer was then compressed to a thickness of about 155 μm.

### C) Preparation of NEG015B as an example of the Negative Electrode Preparation

i) CMC (15 g) was dissolved into deionized water (˜951 g); ii) Carbon black (15 g) was added and mixed for 15 min at the rate of about 6500 rpm; iii) Negative active graphite (JFE Chemical Corporation; Graphitized Mesophase Carbon Micro Bead (MCMB) (945 g) was added to the slurry from Step ii and mixed for 30 min at the rate of about 6500 rpm to form a flowable slurry; iv) SBR (solid content 50% suspended in water) (50 g) was added to the slurry formed in Step iii and mixed at about 6500 rpm for 5 min; v) The viscosity was adjusted for a smooth coating; vi) This slurry was coated onto 9 μm thick copper foil using an automatic coating machine with the first heat zone set to about 100° C. and the second heat zone to about 130° C. to evaporate off the water. The final dried solid loading was about 11 mg/cm². The negative electrode layer was then compressed to a thickness of about 155 μm. The negative made is ready for the dry for the cell assembly.

### D) Preparation of Cell for the Evaluation

i) The electrodes were punched into the pieces with an electrode tab; ii) The positive electrode was dried at ˜125° C. for 10 hr and negative electrode at ˜140° C. for 10 hr; iii)The positive and negative electrodes were laminated with the separator as the middle layer; iv)The jelly-roll made in the Step iii was laid flat in an aluminum composite bag; v) The bag from Step iv. was dried in a 70° C. vacuum oven; vi) The bag from Step v was filled with the carbonate based electrolyte; vii) The bag from Step vi was sealed; viii) Rest for 16 hours; ix) The cell was charged to 4.2V at C/50 rate for 8 hours and then to 4.2V at 0.5 C rate for 2 hours, then rest for 20 minutes, then discharged to 2.8V at 0.5 C rate. The cell made here was used for grading and other tests such as over charge test.

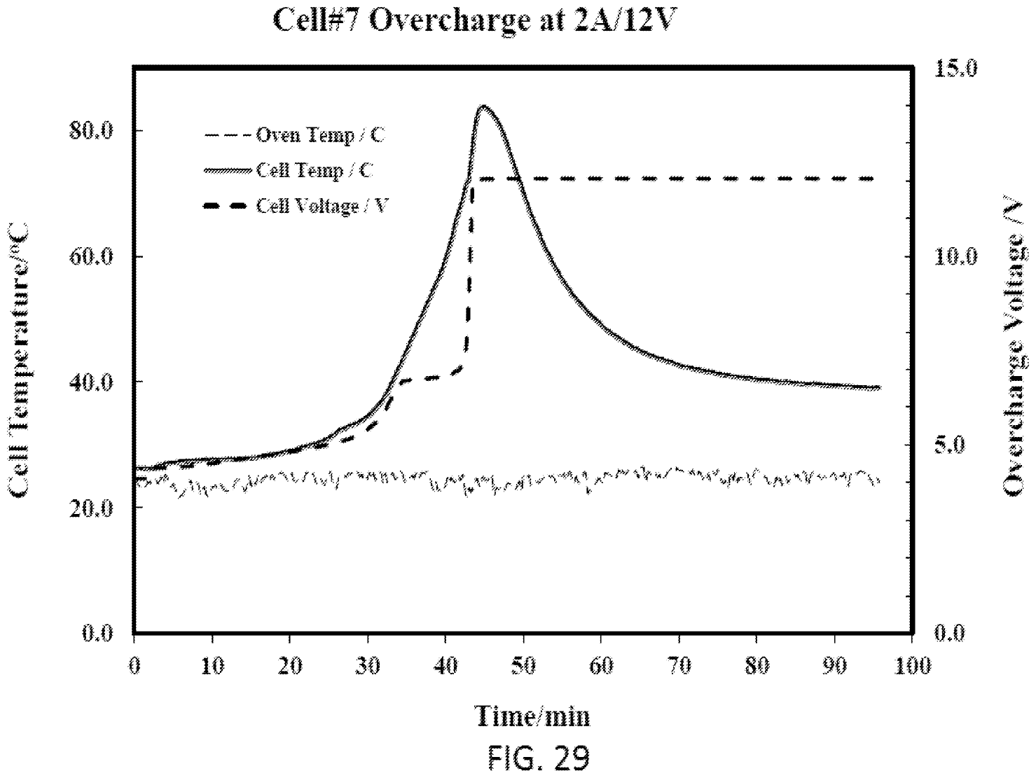

FIG. 29 presents the overcharge voltage, cell temperature and oven chamber temperature during the overcharge test (2 A and 12V) for the cell #7. The cell passed the over test nicely since the cell maximum temperature is about 83° C. during the overcharge test. Implementations of the current subject matter can include, but are not limited to, articles of manufacture (e.g. apparatuses, systems, etc.), methods of making or use, compositions of matter, or the like consistent with the descriptions provided herein.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A high energy density rechargeable metal-ion battery comprising:
an anode energy layer;
a cathode energy layer;
a separator for separating the anode energy layer from the cathode energy layer;
at least one current collector for transferring electrons to and from either the anode or cathode energy layer, the high energy density rechargeable metal-ion battery having an upper temperature safety limit for avoiding thermal runaway; and
an interrupt layer activatable for interrupting current within high energy density rechargeable metal-ion battery upon exposure to temperature at or above the upper temperature safety limit, the interrupt layer interposed between the separator and one of the current collectors, the interrupt layer, when unactivated, being laminated between the separator and one of the current collectors for conducting current therethrough, the interrupt layer, when activated, being delaminated for interrupting current through the high energy density rechargeable metal-ion battery, the interrupt layer including a temperature sensitive decomposable component for decomposing upon exposure to temperature at or above the upper temperature safety limit, the temperature sensitive decomposable component for evolving a gas upon decomposition, the evolved gas for delaminating the interrupt layer for interrupting current through the high energy density metal-ion battery,
wherein the high energy density rechargeable metal-ion battery avoids thermal runaway by activation of the interrupt layer upon exposure to temperature at or above the upper temperature safety limit for interrupting current in high energy density rechargeable metal-ion battery.

2. The high energy density rechargeable metal-ion battery cell of claim 1 wherein:
the interrupt layer is porous;
the temperature sensitive decomposable component comprises a ceramic powder;
the interrupt layer has a composition comprising the ceramic powder, a binder, and a conductive component;
wherein the ceramic powder defines an interstitial space;
the binder partially fills the interstitial space for binding the ceramic powder; and
the conductive component dispersed within the binder for imparting conductivity to the interrupt layer;
the interstitial space remaining partially unfilled for imparting porosity and permeability to the interrupt layer.

3. The high energy density rechargeable metal-ion battery cell of claim 2 wherein the interrupt layer being compressed for reducing the unfilled interstitial space and increasing the binding of the ceramic powder by the binder.

4. The high energy density rechargeable metal-ion battery cell of claim 2 wherein the interrupt layer comprises greater than 30% ceramic powder by weight.

5. The high energy density rechargeable metal-ion battery cell of claim 2 wherein the interrupt layer comprises greater than 50% ceramic powder by weight.

6. The high energy density rechargeable metal-ion battery cell of claim 2 wherein the interrupt layer comprises greater than 70% ceramic powder by weight.

7. The high energy density rechargeable metal-ion battery cell of claim 2 wherein the interrupt layer comprises greater than 75% ceramic powder by weight.

8. The high energy density rechargeable metal-ion battery cell of claim 2 wherein the interrupt layer comprises greater than 80% ceramic powder by weight.

9. The high energy density rechargeable metal-ion battery cell of claim 2 wherein the interrupt layer is permeable to transport of ionic charge carriers.

10. The high energy density rechargeable metal-ion battery cell of claim 1 wherein the interrupt layer is non-porous and having a composition comprising a non-conductive filler, a binder for binding the non-conductive filler, and a conductive component dispersed within the binder for imparting conductivity to the interrupt layer.

11. The high energy density rechargeable metal-ion battery cell of claim 1 wherein the interrupt layer is impermeable to transport of ionic charge carriers.

12. The high energy density rechargeable metal-ion battery cell of claim 1 wherein the interrupt layer is sacrificial at temperatures above the upper temperature safety limit.

13. The high energy density rechargeable metal-ion battery cell of claim 12 wherein the interrupt layer comprises a ceramic powder that chemically decomposes above the upper temperature safety limit for evolving a fire retardant gas.

14. The high energy density rechargeable metal-ion battery cell of claim 1 wherein the current collector includes an anode current collector for transferring electrons to and from the anode energy layer, wherein the interrupt layer being interposed between the separator and the anode current collector.

15. The high energy density rechargeable metal-ion battery cell of claim 14, wherein the interrupt layer being interposed between the anode current collector and the anode energy layer.

16. The high energy density rechargeable metal-ion battery cell of claim 14, wherein the interrupt layer being interposed between the anode energy layer and the separator.

17. The high energy density rechargeable metal-ion battery cell of claim 14 wherein the anode energy layer comprises:
a first anode energy layer; and
a second anode energy layer interposed between the first anode energy and the separator, wherein the interrupt layer being interposed between the first anode energy layer and the second anode energy layer.

18. The high energy density rechargeable metal-ion battery cell of claim 1 wherein the current collector comprises a cathode current collector for transferring electrons to and from the cathode energy layer, wherein the interrupt layer is interposed between the separator and the cathode current collector.

19. The high energy density rechargeable metal-ion battery cell of claim 18, wherein the interrupt layer is interposed between the cathode current collector and the cathode energy layer.

20. The high energy density rechargeable metal-ion battery cell of claim 18, wherein the interrupt layer is interposed between the cathode energy layer and the separator.

21. The high energy density rechargeable metal-ion battery cell of claim 18 wherein the cathode energy layer comprises a first cathode energy layer and a second cathode energy layer interposed between the first cathode energy and the separator, wherein the interrupt layer is interposed between the first cathode energy layer and the second cathode energy layer.

22. The high energy density rechargeable metal-ion battery cell of claim 1 further having two current collectors comprising an anode current collector for transferring electrons to and from the anode energy layer and a cathode current collector for transferring electrons to and from the cathode energy layer, wherein the interrupt layer comprises an anode interrupt layer and a cathode interrupt layer, the anode interrupt layer interposed between the separator and the anode current collector, the cathode interrupt layer interposed between the separator and the cathode current collector.

23. A method for interrupting current within a high energy density rechargeable metal-ion battery upon exposure to temperature at or above an upper temperature safety limit for avoiding thermal runaway, the method comprising:
raising the temperature of the high energy density rechargeable metal-ion battery above the upper temperature safety limit, the high energy density rechargeable metal-ion battery comprising:
an anode energy layer;
a cathode energy layer;
a separator separating the anode energy layer from the cathode energy layer;
a current collector for transferring electrons to and from either the anode or cathode energy layer; and
an interrupt layer, the interrupt layer interposed between the separator and one of the current collectors, the interrupt layer, when unactivated, being laminated between the separator and one of the current collectors for conducting current therethrough, the interrupt layer, when activated, being delaminated for interrupting current through the lithium ion battery, the interrupt layer comprising a temperature sensitive decomposable component for decomposing upon exposure to temperature at or above the upper temperature safety limit, the temperature sensitive decomposable component for evolving a gas upon decomposition, the evolved gas for delaminating the interrupt layer for interrupting current through the high energy density metal-ion battery; and
activating the interrupt layer for interrupting current through the high energy density metal-ion battery; whereby thermal runaway by the high energy density rechargeable metal-ion battery is avoided by interruption of current therethrough.
